(19) United States
(12) Patent Application Publication
(10) Pub. No.: US 2023/0286785 A1
(43) Pub. Date: Sep. 14, 2023

(54) WINCH AND FAIRLEAD ASSEMBLY FOR A VEHICLE

(71) Applicant: Polaris Industries Inc., Medina, MN (US)

(72) Inventors: Aidan Shaughnessy, Overland Park, KS (US); Jeremiah Johnstun, Elk River, MN (US); Paul L. Mattson, Harris, MN (US)

(21) Appl. No.: 18/111,636

(22) Filed: Feb. 20, 2023

Related U.S. Application Data
(60) Provisional application No. 63/319,522, filed on Mar. 14, 2022.

(51) Int. Cl. B66D 1/36; B66D 1/12

(52) U.S. Cl. CPC B66D 1/36; B66D 1/12

(57) ABSTRACT

A winch assembly includes a motor, a drum, and a gearbox. The drum extends from the motor to the gearbox. The winch assembly further includes a housing. The drum extends through the housing. The winch assembly further includes a fairlead. The fairlead is directly coupled to a face of the housing and provides structural support for the winch assembly.

### CROSS REFERENCE TO RELATED APPLICATION

The present disclosure claims priority to U.S. Provisional Application No. 63/319,522, filed Mar. 14, 2022, and entitled “WINCH AND FAIRLEAD ASSEMBLY FOR A VEHICLE,” the entire disclosure of which is expressly incorporated by reference herein.

### BACKGROUND

Vehicles have been developed that include winch assemblies for recovery or load carrying applications. Some vehicles may further include fairleads to guide a rope or cable of a winch assembly.

### SUMMARY

The present disclosure relates generally to a winch assembly with a structurally integrated fairlead.

Some embodiments of the present disclosure provide a winch assembly that includes a motor and a drum. The drum is driven by the motor. The winch assembly further includes a housing. The drum extends through the housing. The winch assembly further includes a fairlead. The fairlead is directly coupled to a face of the housing. The fairlead is configured to couple to at least a portion of a vehicle via one or more fasteners.

Some embodiments of the present disclosure provide a winch assembly that includes a motor and a drum. The drum is driven by the motor. The winch assembly further includes a housing. The drum extends through the housing. The winch assembly further includes a fairlead. The fairlead is coupled to the housing, via one or more fasteners. The housing is coupled directly to the vehicle, via the one or more fasteners.

Some embodiments of the present disclosure provide a vehicle that includes a winch assembly. The winch assembly includes a motor and a drum. The drum is driven by a motor. The winch assembly further includes a housing. The drum extends through the housing. The winch assembly further includes a fairlead. The fairlead is directly coupled to a face of the housing.

Some embodiments of the present disclosure provide a winch assembly that includes a motor, a drum, a housing, and an impact mechanism. The drum extends through the housing. The impact mechanism is driven continuously by the motor and drives the drum with a series of rotational striking blows.

Some embodiments of the present disclosure provide a winch assembly that includes a motor, a drum driven by the motor, a cable fixed the drum and configured to be selectively wound around the drum and unwound from the drum by operation of the motor, a housing, and a controller. The drum extends through the housing. The controller is programmed or otherwise configured to activate and deactivate the motor, and the controller is programmed or otherwise configured to alternately and iteratively rotate the drum in opposite directions, thereby unwinding and winding the cable.

Some embodiments of the present disclosure provide a winch assembly that includes a motor, a drum driven by the motor, a housing, and a controller. The drum extends through the housing. The controller is configured to receive one or more error codes. The controller is programmed or otherwise configured to detect a plurality of error conditions and issue a signal indicative of one or more error codes respectively corresponding to the plurality of error conditions. The controller is configured to provide an indication of the one or more error codes to a user.

Some embodiments of the present disclosure provide a winch assembly that includes a motor, a drum driven by the motor, a housing, and at least one bracket. The drum extends through the housing. The at least one bracket extends about the housing. The housing is coupled to the at least one bracket. Further, the at least one bracket includes a first mounting surface and a second mounting surface. The at least one bracket is configured to mount to a vehicle at the first mounting surface. The first mounting surface defines a first plane. The at least one bracket is further configured to mount to the vehicle at the second mounting surface. The second mounting surface defines a second plane. The first and second planes are non-coplanar. The winch assembly further includes a fairlead. The fairlead is coupled to a face of the at least one bracket.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, where:

FIG. 1 is a top, front, left isometric view of a vehicle having a winch assembly according to an example embodiment of the present disclosure;

FIG. 1A is a front, top, and left perspective view of the winch assembly of FIG. 1

FIG. 1B is a rear, top, and right side perspective view of the winch assembly of FIG. 1;

FIG. 1C is a left side, cross-sectional view of the winch assembly of FIG. 1, taken along plane 1C-1C of FIG. 1A;

FIG. 1D is a top, rear, and right side perspective view of a fairlead and sensor from the winch assembly of FIG. 1;

FIG. 1E is an exploded view of the fairlead and sensor of FIG. 1D;

FIG. 1F is an exploded view of the winch assembly of FIG. 1A;

FIG. 2 is a top, front, left isometric view of a vehicle having a winch assembly according to another example embodiment of the present disclosure;

FIG. 2A is a front, top, and left perspective view of the winch assembly of FIG. 2;

FIG. 2B is a rear, top, and right side perspective view of the winch assembly of FIG. 2;

FIG. 2C is a left side, cross-sectional view of the winch assembly of FIG. 2, taken along plane 2C-2C of FIG. 2A;

FIG. 2D is a top, rear, and right side perspective view of a fairlead and sensor from the winch assembly of FIG. 2;

FIG. 2E is an exploded view of the fairlead and sensor of FIG. 2D;

FIG. 2F is an exploded view of the winch assembly of FIG. 2A;

FIG. 3 is a top, front, left isometric view of a vehicle having a winch assembly according to another example embodiment of the present disclosure;

FIG. 3A is a front, top, and left perspective view of the winch assembly of FIG. 3;

FIG. 3B is a rear, top, and right side perspective view of the winch assembly of FIG. 3;

FIG. 3C is a left side, cross-sectional view of the winch assembly of FIG. 3, taken along plane 3C-3C of FIG. 3A;

FIG. 3D is a top, rear, and right side perspective view of a fairlead and sensor from the winch assembly of FIG. 3;

FIG. 3E is an exploded view of the fairlead and sensor of FIG. 3D;

FIG. 3F is an exploded view of the winch assembly of FIG. 3A;

FIG. 4 is a schematic view of another winch assembly having an impact mechanism;

FIG. 5 is a graph of torque vs. time for impact mechanisms useable with winch assemblies in accordance with the present disclosure; and

FIG. 6 illustrates an example table of error codes for a controller in accordance with the present disclosure.

FIG. 7 is a top, front, left isometric view of a vehicle having a winch assembly according to an example embodiment of the present disclosure;

FIG. 8A is a front, top, and left perspective view of the winch assembly of FIG. 7;

FIG. 8B is a rear, top, and right side perspective view of the winch assembly of FIG. 7;

FIG. 8C is a left side, cross-sectional view of the winch assembly of FIG. 1, taken along plane 8C-8C of FIG. 8A;

FIG. 8D is a top, rear, and right side perspective view of a first bracket and a second bracket from the winch assembly of FIG. 7;

FIG. 8E is a top, rear, and right side perspective view of the first bracket from the winch assembly of FIG. 7;

FIG. 8F is an exploded view of portions of the winch assembly of FIG. 7;

Corresponding reference characters indicate corresponding parts throughout the several views. Unless stated otherwise the drawings are proportional.

### DETAILED DESCRIPTION OF THE DRAWINGS

The embodiments disclosed below are not intended to be exhaustive or to limit the invention to the precise forms disclosed in the following detailed description. Rather, the embodiments are chosen and described so that others skilled in the art may utilize their teachings. While the present disclosure is primarily directed to utility vehicle, and all-terrain vehicles, it should be understood that features disclosed herein may have application to other types of vehicles, such as, for example, other utility vehicles, other all-terrain vehicles, motorcycles, watercrafts, snowmobiles, and golf carts.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As mentioned above, some vehicles may include winches for towing or load carrying applications. Additionally, some vehicles may include fairleads to guide cable out of a winch. For example, a winch assembly that is coupled to the chassis of a utility vehicle is disclosed by U.S. Pat. No. 8,997,908, the complete disclosure of which is expressly incorporated by reference herein.

Further, a winch that is coupled to an all-terrain vehicle via mounting brackets is disclosed by U.S. Pat. No. 9,102,205, the complete disclosure of which is expressly incorporated by reference herein.

Still further, a winch assembly for an all-terrain vehicle is disclosed by U.S. Pat. No. 9,776,481, the complete disclosure of which is expressly incorporated by reference herein.

Still further, a winch assembly that is coupled to an all-terrain vehicle is disclosed by U.S. Pat. No. 9,944,177, the complete disclosure of which is expressly incorporated by reference herein.

Large, heavy, and/or expensive brackets may be required in order to attach conventional fairleads to winch assemblies (e.g., winch assemblies used in heavy-duty applications). Therefore, using conventional techniques, it may be necessary to couple a fairlead to a bumper or vehicle frame, using one or more brackets, for the fairlead to be adequately supported for use with a winch assembly. Accordingly, there exists a need for combined winch and fairlead assemblies that are compact, require fewer parts (e.g., no brackets between the winch assembly and fairlead), and are easy to install (e.g., by way of production at the time of manufacture, instead of via retrofit, or post-production attachment).

Generally, as explained herein, the present disclosure provides a winch assembly with a structurally integrated fairlead for a vehicle. The winch assembly may include a rotatable drum, driven by a motor and gearbox, to pull in, or let out, a rope or cable wound around the drum. Further, the winch assembly may include a housing with a fairlead directly coupled to the housing, to enclose the drum. The structurally integrated fairlead may prevent the cable or rope from becoming tangled, as the cable or rope is pulled in or let out. Further, the winch assembly may be directly coupled to the front end of the vehicle (e.g., to a bumper of the vehicle, or to a chassis of the vehicle). A winch assembly in accordance with the present disclosure may therefore lack any dedicated brackets positioned between the winch housing and the vehicle, or between the fairlead and the winch housing. Rather, as described in further detail below, the fairlead is fixed directly to the housing, and the housing is fixed directly to a component of the vehicle which also serves another purpose (such as a frame or bumper).

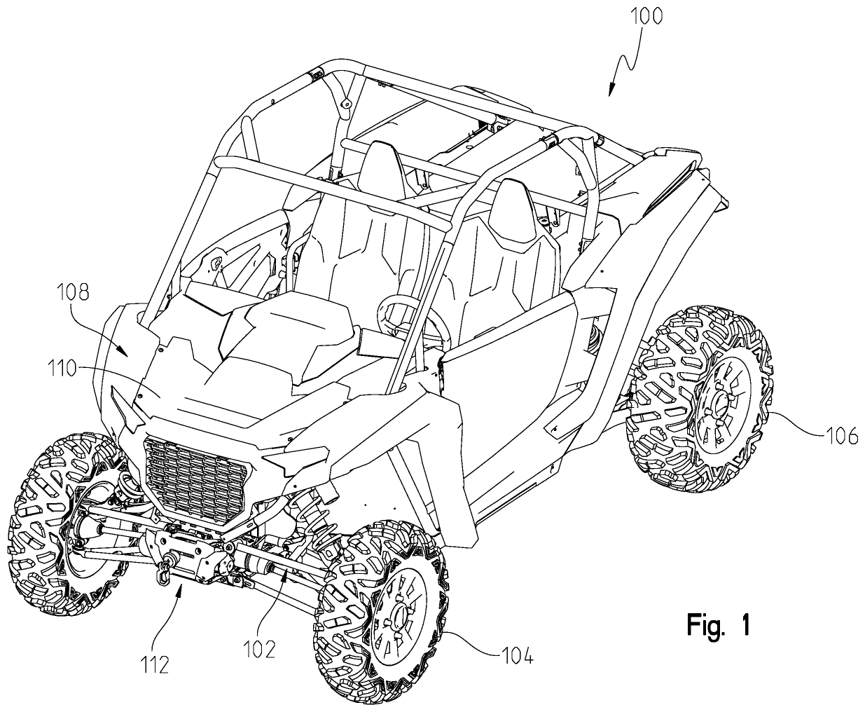

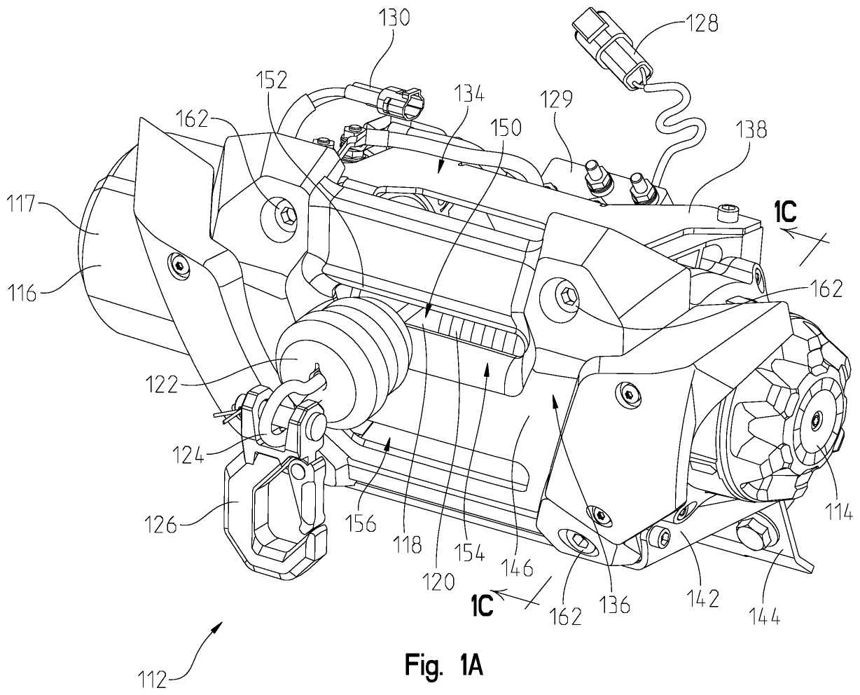

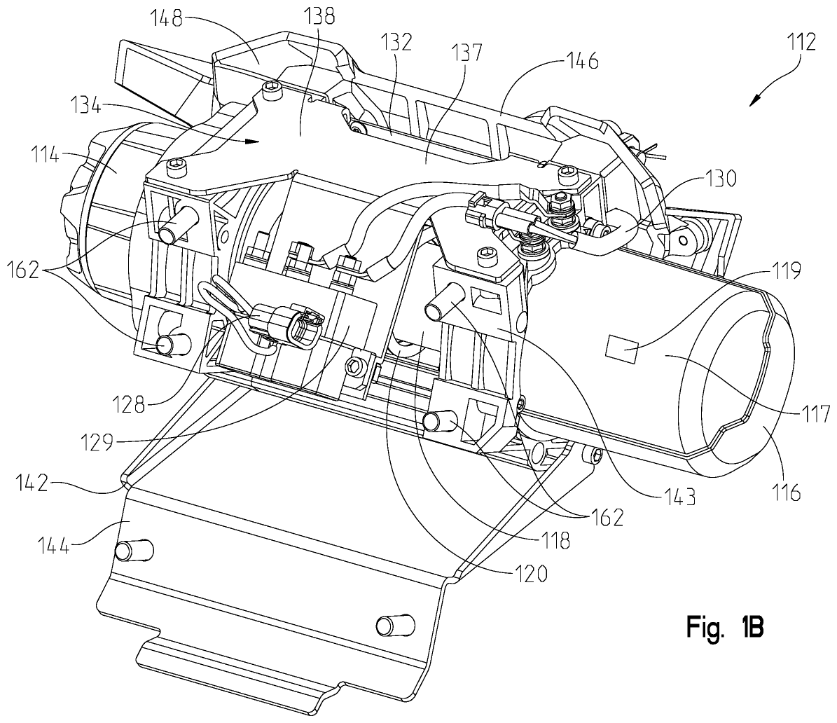

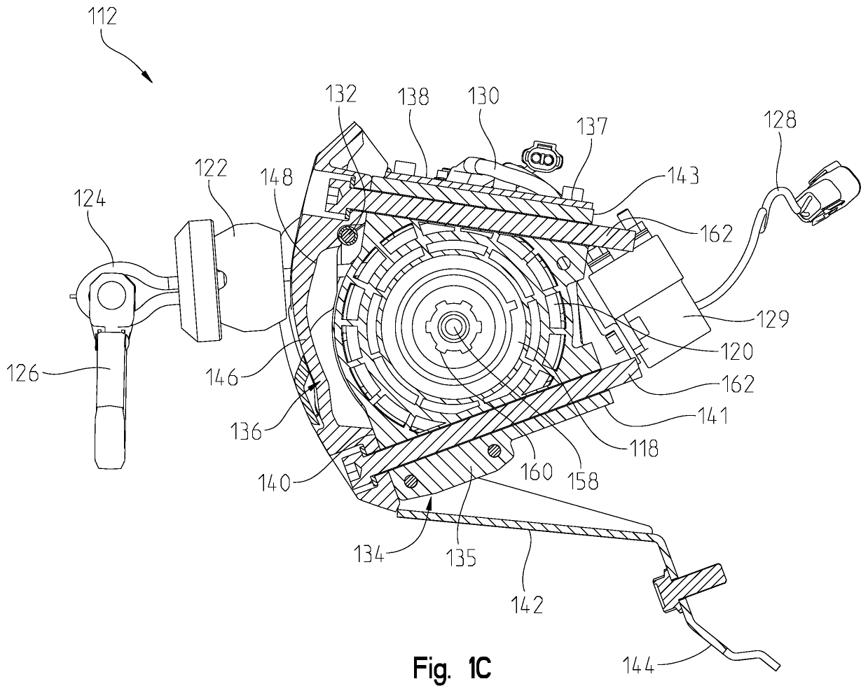

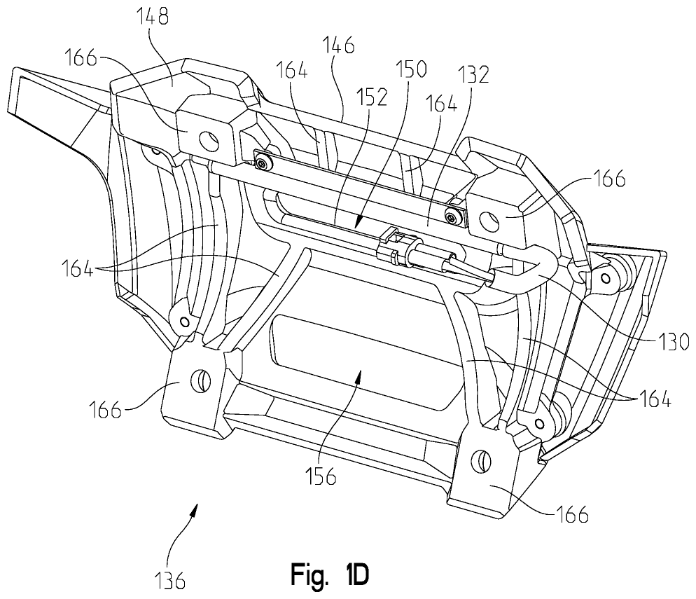

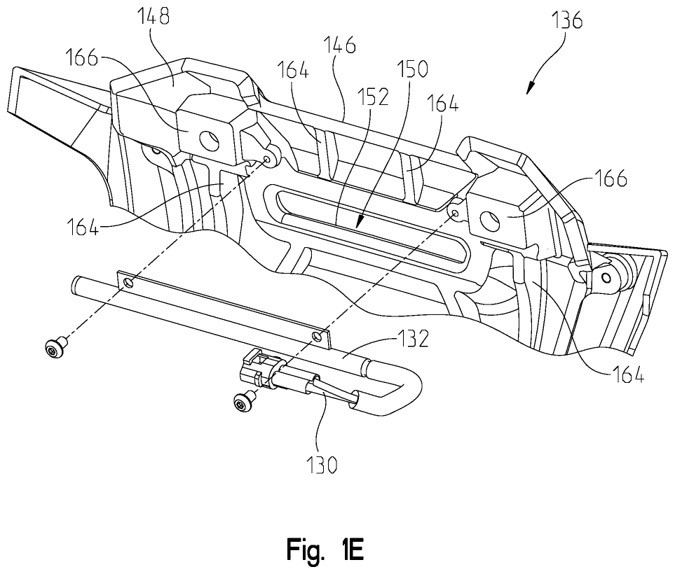

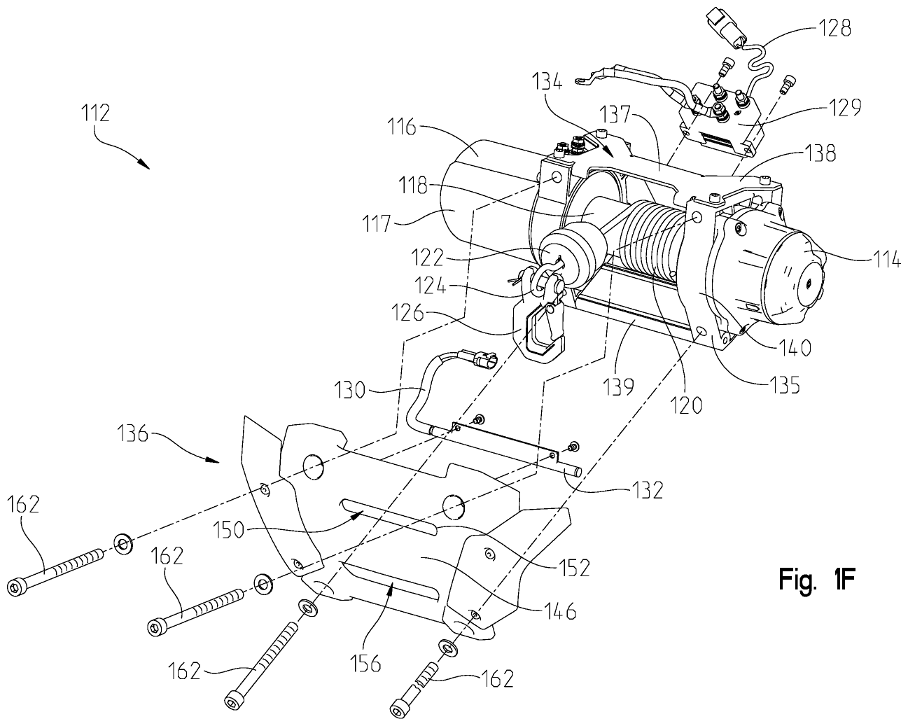

With reference to FIG. 1, an example vehicle 100 is shown. The vehicle 100 may be an all-terrain vehicle (ATV), a utility terrain vehicle (UTV), or other off-road vehicle (ORV). In other examples, vehicle 100 may include other vehicles, including, but not limited to, boats, personal transport vehicles, or other recreational vehicles. The vehicle 100 is shown generally to include a frame 102 supported by a plurality of ground engaging members, for example, front wheels 104 and rear wheels 106. The vehicle 100 includes a front end 108 having a hood 110, an engine (not shown), and a winch assembly 112 coupled to the frame 102. The winch assembly 112 may be directly coupled to the frame 102 (e.g., via one or more bolts, screws, or rivets), as further described in detail below.

FIG. 1A illustrates a front, top, and left perspective view of the winch assembly 112, and FIG. 1B illustrates a rear, top, and right perspective view of the winch assembly 112. The winch assembly 112 includes a gearbox 114, a motor 116, and a drum 118. The drum 118 extends from the gearbox 114 to the motor 116. The motor 116 may provide power to the gearbox 114, and the gearbox 114 may rotate the drum 118. In some embodiments, the motor 116 may be a brushless direct current (DC) motor, though other motor types may also be used as required or desired for a particular application. The gearbox 114 may provide a speed reduction such that the rotational speed of the motor 116, which is the input to the gearbox 114, is reduced to a lower rotational speed of the drum 118, which is the output of the gearbox 114. In some embodiments, the gearbox 114 may be a single-stage reduction accomplished with a single set of gears, while other embodiments may use multi-stage reductions accomplished with multiple sets of gears. Gearbox 114 may use planetary-type gearsets for single or multi-stage reductions. In still other embodiments, gearbox 114 may be eliminated entirely, with a direct drive between the motor 116 and the drum 118.

In some examples, the motor 116 includes a motor cover 117 that encloses at least a portion of the motor 116. In some examples, the motor cover 117 includes an isolator connector or isolator 119 (FIG. 1B) that extends through the motor cover 117. The isolator 119 may allow for cables, such as power cables, to be connected to components inside of the motor cover 117, such as the motor 116, from outside of the motor cover 117. Therefore, power cables may be connected to the motor 116 while the motor 116 (e.g., and associated wiring) are enclosed within the motor cover 117. The isolator 119 may allow for ease of assembly for electrical components and/or reduce risk of damaging cables/wires, such as from passing cables/wires directly through holes in the motor cover 117 and/or routing such cables/wires from such holes to power sources or controllers via exposed or circuitous pathways.

A rope or cable 120 is wrapped around the drum 118. The cable 120 may wind-up, or un-wind from the drum 118, depending on the rotation of the drum 118 (e.g., the rotation applied by the gearbox 114, when the gearbox 114 receives power from the motor 116).

A winch head 122 is attached to an end of the rope or cable 120. The winch head 122 may be made at least in part of metal (e.g., it may be made of steel, or include a portion made of steel). The winch head 122 includes a winch hook 124 extending therefrom. A load hook 126 may be attached to the winch hook 124 (e.g., via a pin lock mechanism, or hooked attachment). When the winch assembly 112 is in use, the load hook 126 may be attached to a load (e.g., a vehicle to be towed, or an object to be pulled towards vehicle 100, or towards which the vehicle 100 is to be pulled). The motor 116 may be activated to drive the gearbox 114, such that the drum 118 rotates, the rope or cable 120 is wound-up around the drum, and the winch head 122 and load hook 126 are pulled towards the drum 118, thereby closing the distance between the vehicle 100 and the load hook 126, together with any structure to which hook 126 may be attached.

In the illustrated embodiment, motor 116 is an electrical motor powered by energizing a copper coil with DC electrical power. A first or motor electrical connector 128 (FIGS. 1A-1C) extends from the motor 116. The motor electrical connector 128 may transmit high-current power to the motor 116 from a power source, for example, a battery or generator (not shown) of the vehicle 100. The motor electrical connector 128 may extend from a contactor 129. The contactor 129 may be a large electromechanical switch. Both the motor electrical connector 128 and the contactor 129 may be housed within (e.g., entirely within) the chassis of a vehicle, when assembled thereto, such as when the fasteners 162 are assembled to the frame 102 of vehicle 100 (e.g., as may be understood from FIG. 1C). Housing the motor electrical connector 128 and the contactor 129 entirely within a chassis of a vehicle helps to protect the motor electrical connector 128 and the contactor 129 from being damaged. Additional and/or alternative advantages of housing specific components within a chassis of a vehicle may be recognized by those of ordinary skill in the art. Further, a second or sensor electrical connector 130 extends from a sensor 132, as illustrated in FIG. 1B. The sensor electrical connector 130 may provide low-current power to the sensor 132 from a power source, for example, a battery (not shown) of the vehicle 100. The sensor 132 is described in further detail below with respect to FIGS. 1D and 1E.

The winch assembly 112 further includes a housing 134 and a fairlead 136. The housing 134 and the fairlead 136, in combination, form an enclosure around and completely encircling the drum 118. The drum 118 extends longitudinally through the housing 134. The fairlead 136 may be structurally integrated with the housing 134. For example, when the winch assembly 112 is in use, the fairlead 136 may absorb stresses or strains (e.g., stresses or strains resulting from torsion) generated by the cable 120 winding, or unwinding, from the drum 118. That is, the fairlead 136 forms an integral, load-bearing component of the winch assembly 112 and is designed to directly provide the torsional rigidity of the assembly 112, in addition to bearing incidental loads placed upon the fairlead 136 by contact with the rope or cable 120.

By contrast, conventional winches may absorb all of the stresses or strains generated by a rope or cable winding, or unwinding, from a drum, while the fairlead is not structurally stressed except insofar as the rope or cable places incidental forces on the fairlead by direct contact between the rope or cable and the fairlead. Alternatively, conventional winches may use intermediary brackets to which the fairlead is mounted, and the bracket may absorb the stresses or strains generated by a rope or cable winding, or unwinding, from a drum. Accordingly, winch assembly 112 provides for a streamlined compact assembly that is structurally beneficial for a vehicle with load carrying capabilities (e.g., vehicles with winch assemblies).

In the illustrative embodiment of FIGS. 1C and 1F, the housing 134 may be an assembly of parts fixed to one another (e.g., by bolted connections). Housing 134 includes a housing base 135 which includes two endcaps having motor 116 and gearbox 114 respectively fixed thereto. A top plate 137 is bolted to each endcap of the housing base 135, as illustrated in FIG. 1B. The endcaps of housing base 135 are similarly joined by one or more tie rods 139 (FIG. 1F) at their bottom surface. Thus, the housing 134 defines a first or top housing side or face 138 (FIGS. 1C and 1F), a second or front housing side or face 140 (FIGS. 1C and 1F), a third or bottom housing side or face 141 (FIG. 1C), and a fourth or rear housing side or face 143 (FIG. 1B). The top housing side 138 may be a formed by top plate 137, which illustratively has a bow-tie shape (e.g., having corners that protrude outward from a prolonged center portion). Referring to FIGS. 1A-1C, a plate 142 may be fixed to housing base 135 and extend from the front housing side 140, and rearward of the drum 118. Plate 142 extends further down and back, forming a support flange 144 which can be fixed (e.g., bolted) to vehicle 100.

The fairlead 136 includes a first or front fairlead face or side 146 and a second or rear fairlead face or side 148. The first fairlead face 146 is an exterior face. The second fairlead face 148 is an interior face that abuts the front housing side 140, when the winch assembly 112 is assembled as shown in FIG. 1C. The fairlead 136 includes a first slot 150 that extends longitudinally along the extend of the drum 118, from a first side near the motor 116 to a second side near the gearbox 114, when the winch assembly 112 is assembled. The first slot 150 extends through the fairlead 136 from the front fairlead face 146 to the rear fairlead face 148. In the illustrated embodiment of FIGS. 1-1F, the first slot is generally oval shaped. It is contemplated that in other embodiments, the first slot may be rectangular or another elongate polygonal or curvilinear shape. The rope or cable 120 extends through the first slot 150, at least when the winch assembly 112 is in use (e.g., winding in, or winding out, a load). The first slot 150 may have one or more curved edges 152. The curved edges 152 may provide a smooth surface for the rope or cable 120 to rest upon, or be guided along, without generating an excess amount of friction.

The first slot 150 may be formed within a depressed region 154 of the fairlead 136. The depressed region provides an angled surface which helps guide the rope or cable 120 when being wound or unwound at extreme angles relative to the orientation of the vehicle 100. In addition, the depressed region 154 of the fairlead 136 forms a divot that at least partially receives the winch head 122, when the rope or cable 120 is fully wound up around the drum 118. The depressed region 154 of the fairlead 136, on the front fairlead face 146, allows the winch head 122 to be compactly secured to the fairlead 136, when the rope or cable 120 is fully wound up.

The fairlead 136 may further include a second slot 156. The second slot 156 may be offset from, and disposed below, the first slot 150. Similar to the first slot 150, the second slot 156 may extend longitudinally from the motor 116 to the gearbox 114, when the winch assembly 112 is assembled. The second slot 156 may reduce the cost of manufacturing the fairlead 136 by eliminating material (e.g., during a manufacturing process, such as forging, or casting) that may not otherwise provide structural support. Additionally, the second slot 156 may provide access to another portion of the drum 118 to aid in service or replacement of the rope or cable 120.

FIG. 1C is a right side, cross-sectional view of the winch assembly of FIG. 1, taken along plane 1C-1C of FIG. 1A. As shown in FIG. 1C, the fairlead 136 is mounted immediately adjacent (i.e., in contact with) the housing 134. The fairlead 136 and housing 134, in combination, form an enclosure around the drum 118. As shown in FIG. 1C, the fairlead 136 extends along a curved or arcuate path from the bottom housing side 142 to the top housing side 138. The curvature of the fairlead 136 improves distribution of stresses and strains resulting from the rotating drum 118, when in use, for example, when the cable 120 of the drum 118 is winding in a load (not shown) towards the winch assembly 112. The fairlead 136 has a generally convex curvature at its outer surface with respect to the housing 134.

An axle 158 extends through the central longitudinal axis of the drum 118. The axle 158 has protrusions 160 extending therefrom that allow the gearbox 114 to transmit torque to the axle 158, and thereby rotate the drum 118. In the example embodiment of FIG. 1C, the axle 158 includes six protrusions 160. The six protrusions 160 are diametrically opposed and axially symmetric around the central longitudinal axis of the drum 118.

Still referring to FIG. 1C, the winch assembly 112 includes one or more fasteners 162 (e.g., bolts, screws, or rivets) that extend from the front fairlead face 146, through the fairlead 136, through the housing 134, and that exit the housing 134 and protrude beyond the rear surface 143. The fasteners 162 may extend through each of the four laterally and diametrically opposed corners of the fairlead 136. Less than four fasteners 162 may be sufficient for some applications, while additional fasteners 162 may be used as required or desired for other applications. In the example embodiment of FIGS. 1-1F, there are four fasteners 162 that couple the fairlead 136 to the housing 134. The fasteners 162 also couple the winch assembly 112 directly to the frame 102 of the vehicle 100 (see FIG. 1). As illustrated in FIG. 1C, the longitudinal axes of the top pair of fasteners are convergent with the longitudinal axes of the bottom pair of fasteners along the front-to-back direction. FIG. 1F is an exploded view of the winch assembly 112, illustrating how the fasteners 162 are inserted through the fairlead 136 and the housing 134 along their respectively converging axes. The converging axes of the fasteners 162 allows for the winch assembly 112 to be coupled to a non-planar receiving surface on a vehicle frame (e.g., frame 102 of vehicle 100). Additionally, or alternatively, the converging axes of the fasteners 162 may improve load transfer from winch assembly to vehicle 100 compared to winch assemblies without fasteners having converging axes.

Mechanical devices under high loads are subject to a variety of forces which are evaluated to test durability. A device with fewer components may be relatively more durable, and longer lasting, than a device with many components, because component junctions can be failure points. The embodiment of FIGS. 1-1F has only four fasteners 162 that both structurally integrate the fairlead 136 into the housing 134 and couple the winch assembly 112 to the vehicle 100. Therefore, the winch assembly 112 provides a compact durable structure that may have improved durability compared to a winch assembly having a greater number of components. In addition, the tension within the four fasteners 162 is maintained by the ability of each fastener to pass freely through fairlead 136 and housing 134, and are connected only to the frame of vehicle 100.

FIG. 1D is a top, rear, and right side perspective view of the fairlead 136 and the sensor 132 from the winch assembly 112, and FIG. 1E is an exploded view of the fairlead 136 and the sensor 132. As illustrated, the fairlead 136 further includes a plurality of ribs 164 which may provide structural rigidity and torsional strength to fairlead 136. The ribs 164 may be formed in the rear fairlead side 148, within the generally concave curvature of the rear fairlead side 148. The ribs 164 are therefore formed on the inner surface of the fairlead 136, out of view when winch assembly 112 is assembled, such that the front fairlead face 146 can be clean and aesthetically appealing. Additionally, or alternatively, one or more ribs may be formed on an outer surface of fairlead 136. The ribs 164 may help to prevent plastic, or non-plastic, deformation of the fairlead 136, when the fairlead 136 is coupled to, and structurally integrated with, the housing 134.

The fairlead 136 is designed to be compactly attachable to the housing 134. To that end, the fairlead 136 may include mounting platforms 166 that protrude from the rear fairlead side 148. As shown in FIGS. 1C and 1F, the mounting platforms 166 shown in FIG. 1D receive the fasteners 162 to couple the fairlead 136 to the housing 134. The mounting platforms 166 may define planar surfaces that mate to the front housing side 140. In this way, fairlead 136 may ensure that tension is maintained in fasteners 162 even during heavy use.

The fairlead 136 is a durable, compact structure. The ribs 164 may extend between the mounting platforms 166 to provide support to the winch assembly 112, when in use (e.g., when towing a load). Additionally, or alternatively, the ribs 164 may extend between the mounting platforms 166 and the first slot 150. The first slot 150 supports the rope or cable 120. Therefore, the ribs 164 that extend between the mounting platforms 166 and the first slot 150 may provide additional support to the winch assembly 112, thereby contributing to the durability of the winch assembly 112 having a structurally integral fairlead 136.

In one embodiment, the load bearing capacity of the fairlead 136 is at least an order of magnitude larger than the adjacent structures near the front surface 140, such as tierod 139 or the front portion of the top plate 137. For example, tierod 139 and top plate 137 may have sufficient strength and rigidity to hold the intended shape and structure of winch assembly 112 when not in use (e.g., during service or installation), while fairlead 136 is the structure which provides strength and rigidity at the front surface 140 sufficient to absorb the dynamic forces placed upon winch assembly 112 during operation.

Still referring to FIG. 1D, and as briefly mentioned above, the winch assembly may include a sensor 132. The sensor 132 is coupled to the rear fairlead face 148, adjacent to the first slot 150. In the illustrated embodiments, the sensor 132 is coupled to the rear fairlead face 148 via a plurality of fasteners (FIG. 1E) which connect directly to fairlead 136 without any additional brackets or inserts. For example, fairlead 136 may be a cast part which includes a dedicated space for sensor 132 in the casting. Additionally, or alternatively, in some embodiments, the sensor 132 may be attached to the rear fairlead face 148 via adhesive, hooks or any other suitable attachment. In the illustrated embodiment, the sensor 132 is an inductive sensor, such that when the winch head 122 approaches the first slot 150, the sensor 132 changes between its activated and deactivated states. Specifically, the sensor 132 may be configured detect ferrous metal (e.g., steel) in the winch head 122. Thus, as the winch head 122 approaches the sensor 132, the sensor 132 changes its state of activation when it detects a change in inductance within the proximity of the sensor 132. The state change of the sensor 132 from a first state to a second state may issue a signal, which may be received by a controller and/or be otherwise used to notify an operator of the vehicle 100 that the winch head 122 is fully wound up, or that the winch head 122 is not fully wound up. This feature may be particularly useful in certain applications, such as operation of snow plows, where the winch head 122 is frequently toggled between being fully wound up and partially wound up.

Alternatively, the sensor 132 may be a reed switch. For example, a paddle or other moveable structure on the sensor 132 may be physically contacted by the winch head 122 to change the sensor 132 from a first state to a second state. Similarly, as discussed above, the state change of the sensor 132 from the first state to the second state, may issue a signal to a controller and/or notify an operator of the vehicle 100 that the winch head is fully wound up, or that the winch head is not fully wound up.

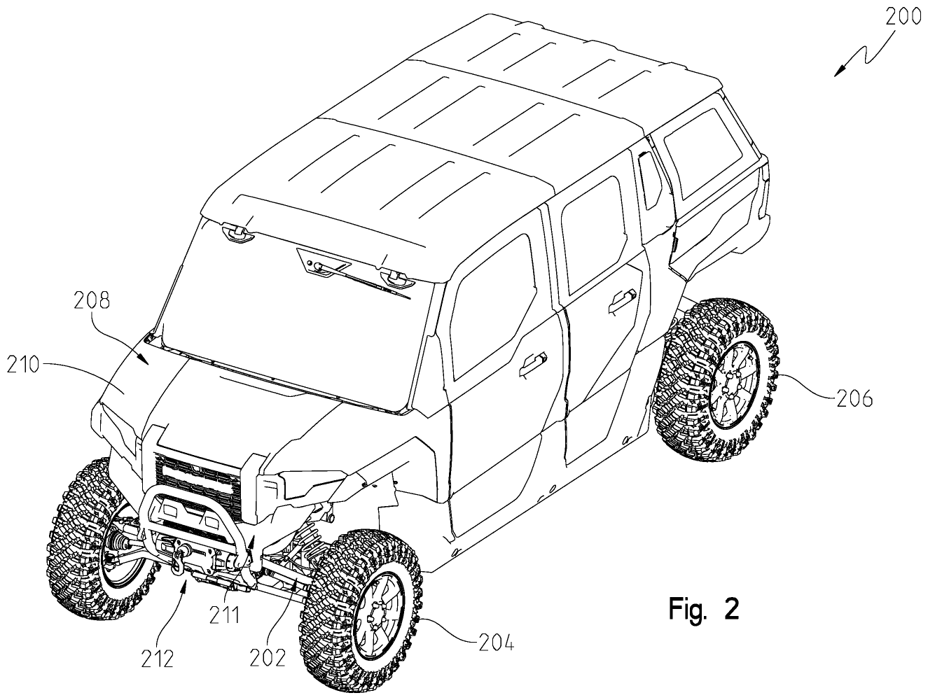

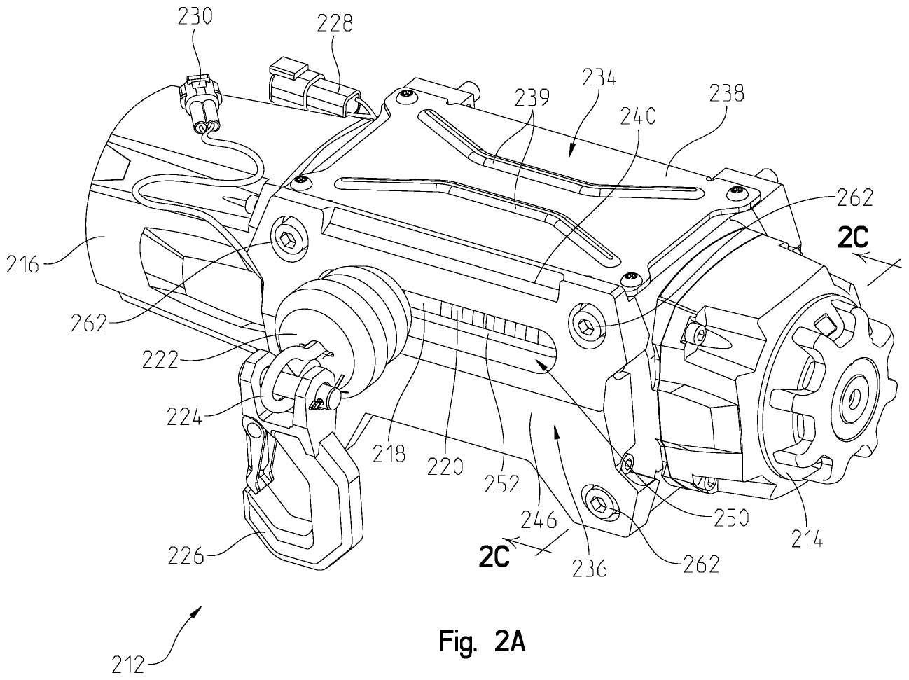

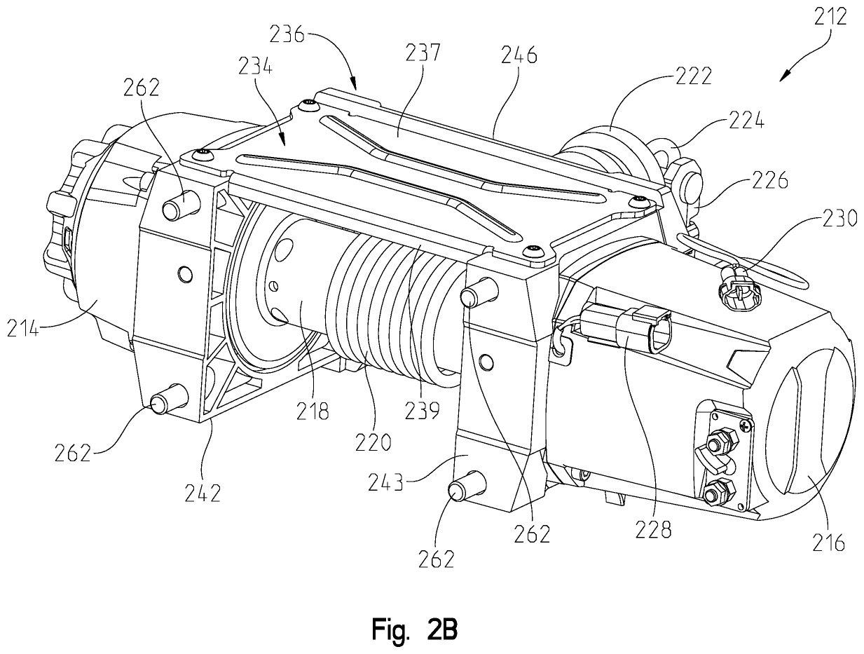

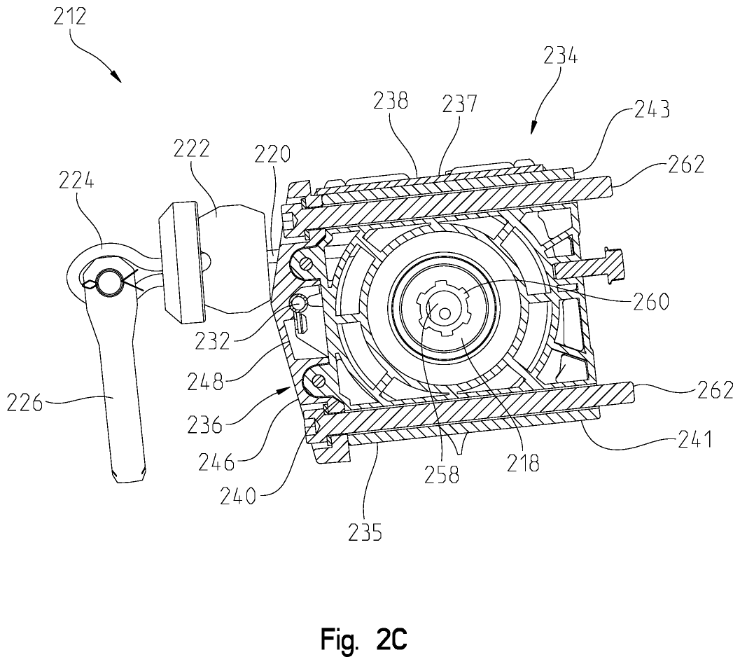

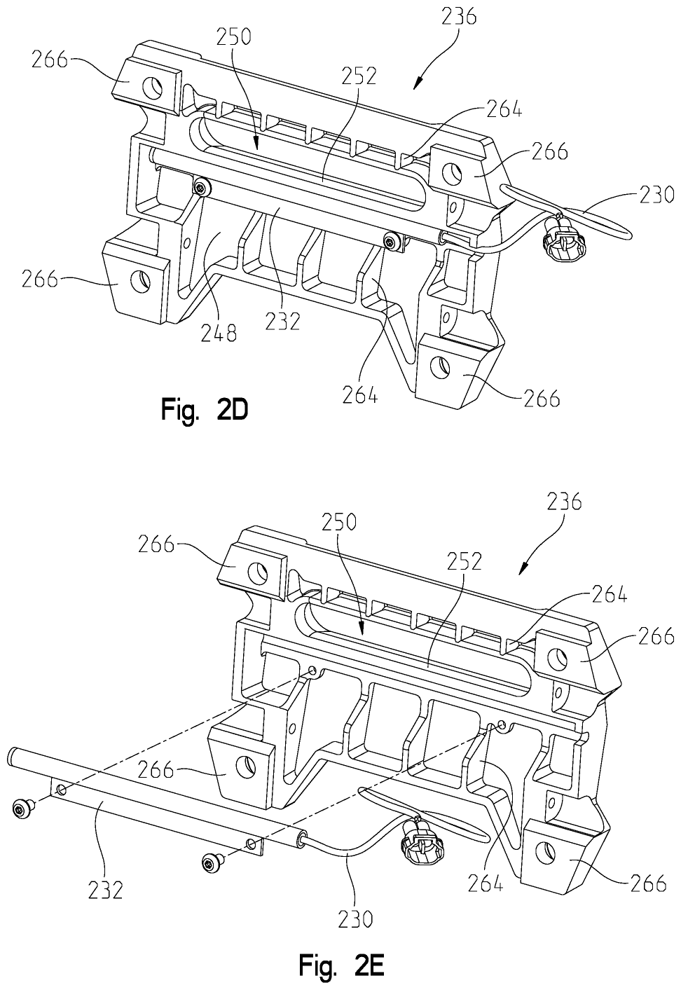

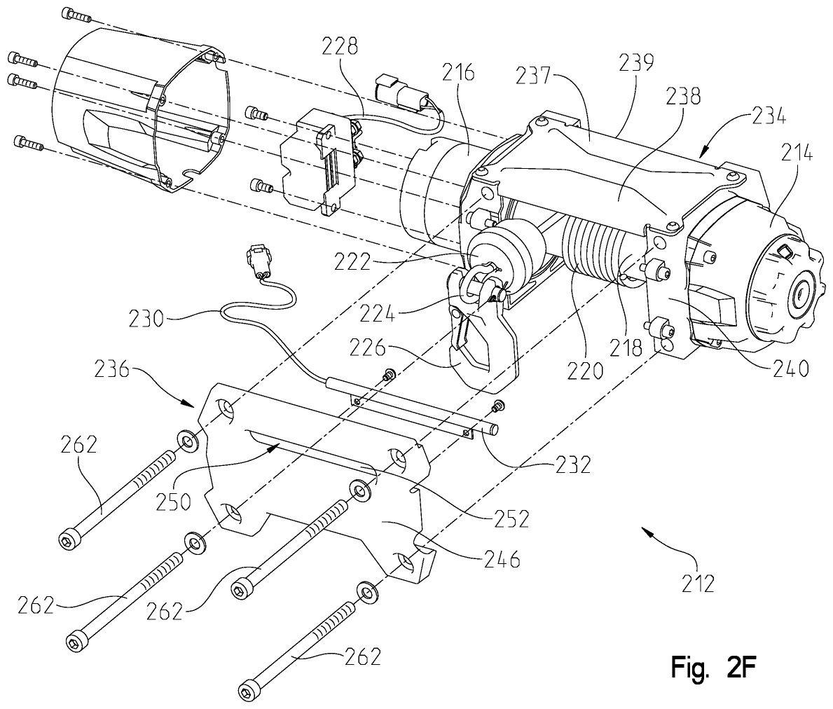

Turning now to FIG. 2, an example vehicle 200 is shown. The vehicle 200 may be a utility task vehicle (UTV). The vehicle 200 is shown generally to include a frame 202 supported by a plurality of ground engaging members, for example, front wheels 204 and rear wheels 206. The vehicle 200 includes a front end 208 having a hood 210, an engine (not shown), a bumper 211, and a winch assembly 212 coupled to the frame 202.

The winch assembly 212 is illustrated further in FIGS. 2A-2F. In some aspects, the winch assembly 212 may be substantially similar to the winch assembly 112, discussed with respect to FIGS. 1-1F, except as described herein.

Similar elements between winch assembly 112 and winch assembly 212 are provided with similar reference numbers that have been incremented by 100. For example, winch assembly 212 includes a gearbox 214, a motor 216, a drum 218, a rope or cable 220, a winch head 222, a winch hook 224, a load hook 226, a first electrical connector 228, a second electrical connector 230, a sensor 232, a housing 234, a housing base 235, a fairlead 236, a top plate 237, a top housing side 238, a front housing side 240, a bottom housing side 241, a rear housing side 243, a front fairlead face 246, a rear fairlead face 248, a first slot 250, curved edges 252, an axle 258, protrusions 260, fasteners 262, ribs 264, and mounting platforms 266.

In some aspects, the winch assembly 212 differs from the winch assembly 112. For example, fasteners 262 have longitudinal axes that are all parallel to one another, and rear housing side 243 has correspondingly coplanar surfaces designed to abut a planar mounting surface on vehicle 200. Housing base 235 and the other components of winch assembly 212 are reconfigured in service of this differing shape and configuration of its mounting. Front housing side 240 and fairlead 236 have approximately the same vertical and horizontal extent as the rear housing side, and top housing side 238 has generally the same depth and horizonal extent as bottom housing side 241. Thus, housing base 235 and fairlead 236 of winch assembly 212 cooperate to define a generally cuboid shape enclosing drum 218 and cable 220.

As shown in FIGS. 2A, 2B and 2F, the top plate 237 defines a top housing side 238 that is generally rectangular. Further, the top plate 237 includes ridges 239 (FIGS. 2B and 2F) extending longitudinally between the gearbox 214 and the motor 216. The ridges 239 may supplement the structural support provided by fairlead 236 at the top housing side 238 to handle stresses and strains generated by the drum 218, when the drum 218 is torquing a load.

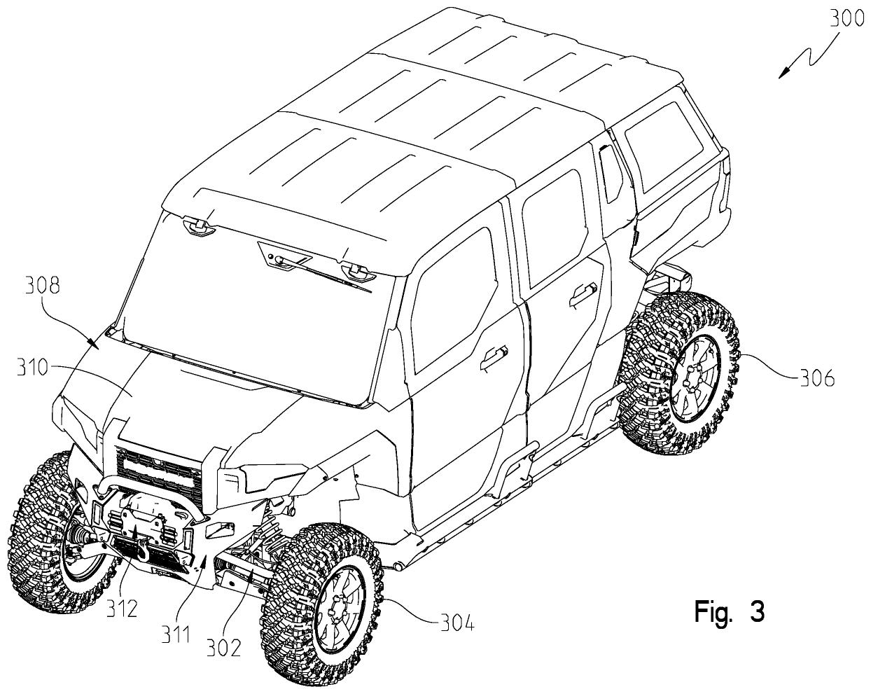

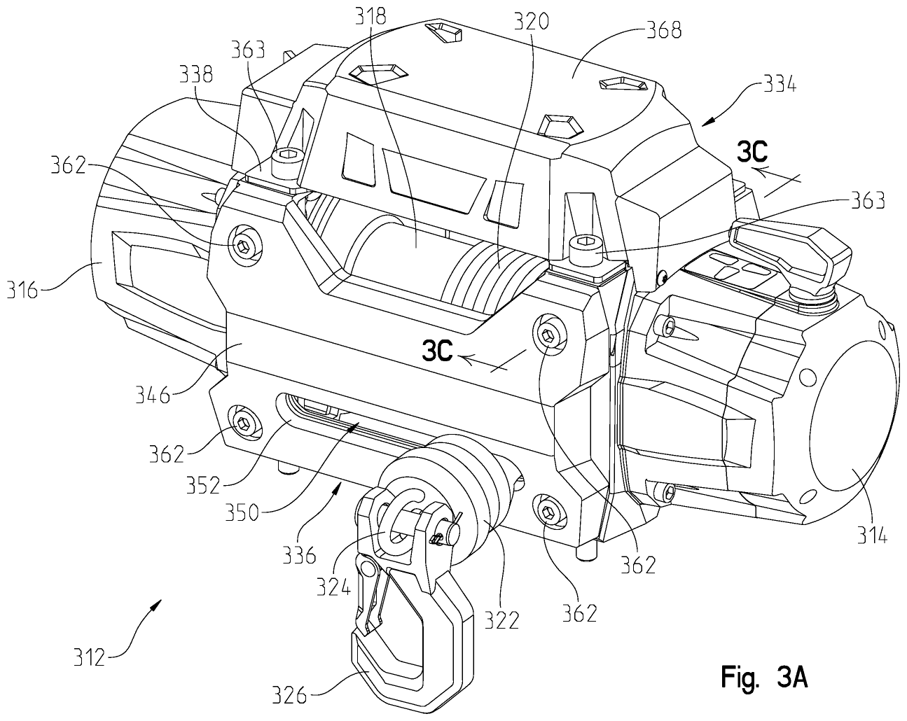

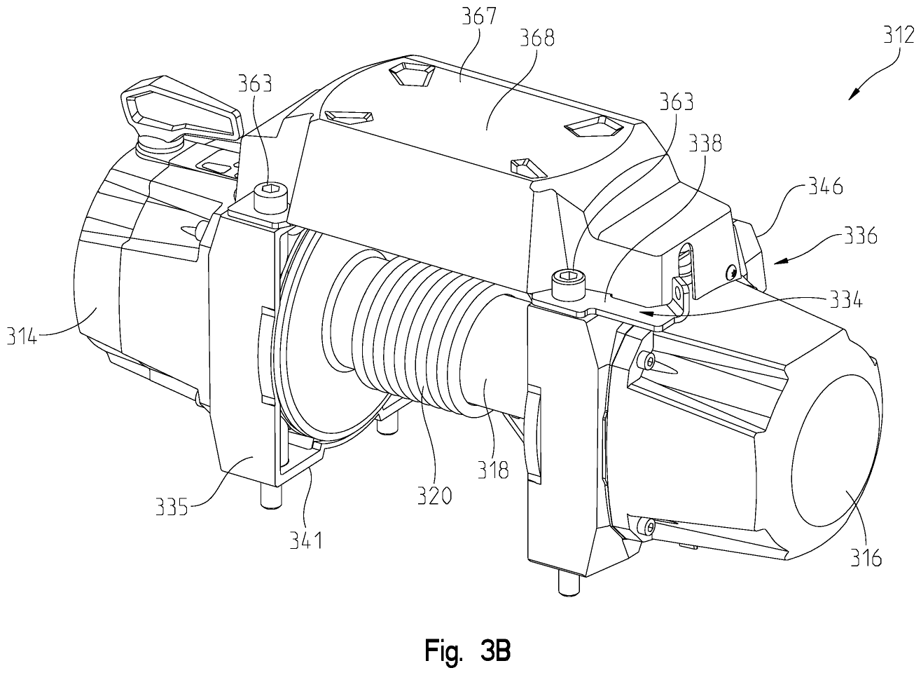

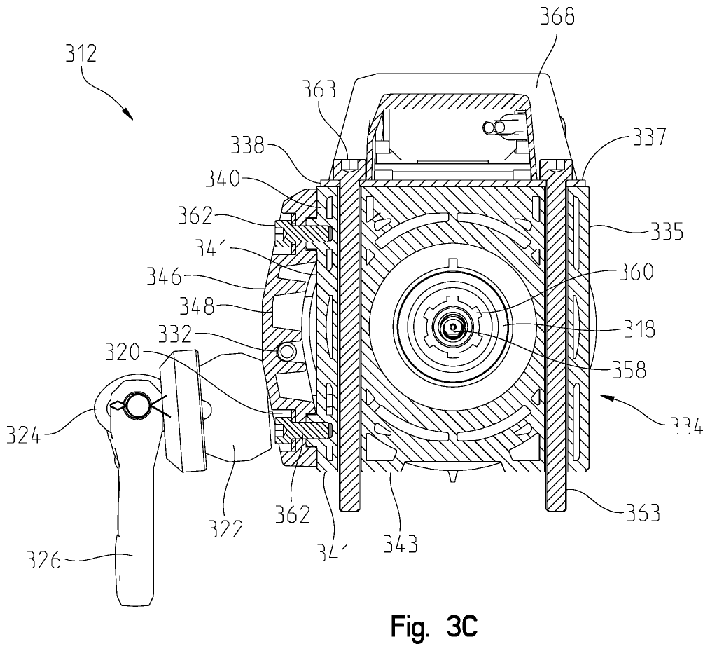

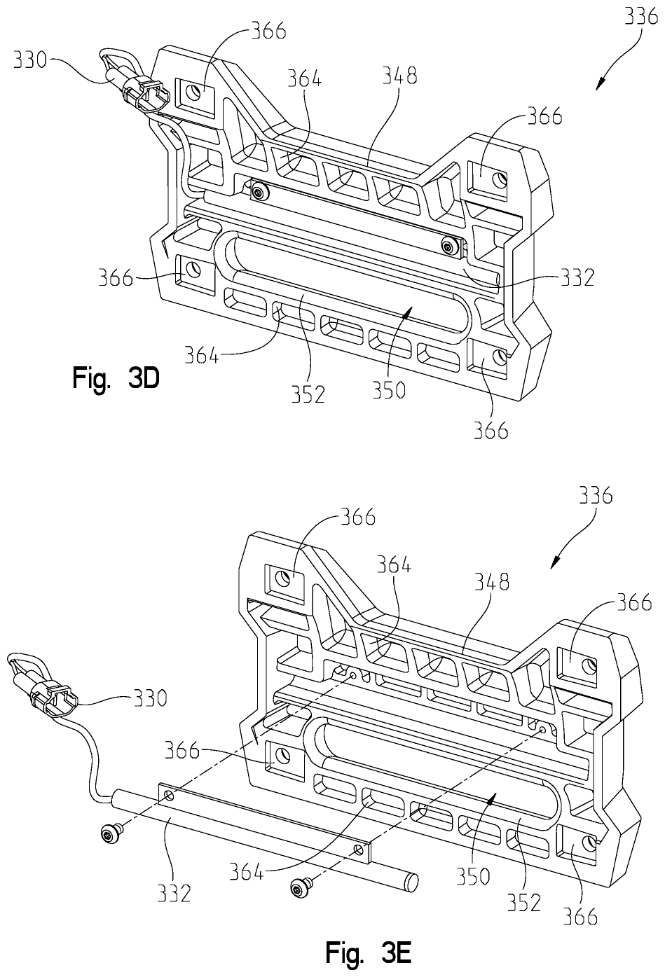

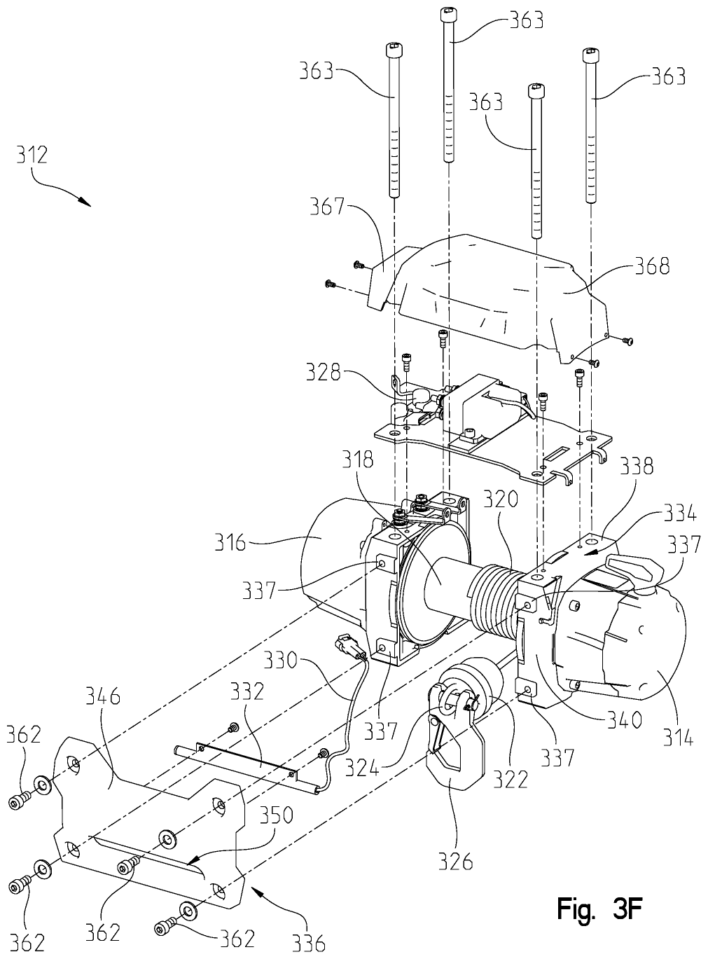

With reference to FIG. 3, an example vehicle 300 is shown. The vehicle 300 may be a utility task vehicle (UTV). The vehicle 300 is shown generally to include a frame 302 supported by a plurality of ground engaging members, for example, front wheels 304 and rear wheels 306. The vehicle 300 includes a front end 308 having a hood 310, an engine (not shown), a bumper 311, and a winch assembly 312 coupled to the bumper 311.

The winch assembly 312 is illustrated further in FIGS. 3A-3F. In some aspects, the winch assembly 312 may be substantially similar to the winch assemblies 112 and 212, discussed with respect to FIGS. 1 and 2, except as described herein.

Similar elements between winch assemblies 112, 212 and winch assembly 312 are provided with similar reference numbers that have been incremented by 200 (i.e., with respect to FIG. 1), or 100 (i.e., with respect to FIG. 2). For example, winch assembly 312 includes a gearbox 314, a motor 316, a drum 318, a rope or cable 320, a winch head 322, a winch hook 324, a load hook 326, a first electrical connector 328, a second electrical connector 330, a sensor 332, a housing 334, a housing base 335, a fairlead 336, a top housing side 338, a front housing side 340, a bottom housing side 341, a rear housing side 343, a front fairlead face 346, a rear fairlead face 348, a first slot 350, curved edges 352, an axle 358, protrusions 360, fasteners 362, ribs 364, mounting platforms 366, top plate 367 and top housing side 368.

In some aspects, the winch assembly 312 differs from the winch assembly 212. For example, the winch assembly 312 is configured to couple directly to a horizontal surface, such as an upwardly-facing surface of the bumper 311 of the vehicle 300. The winch assembly 212, by contrast, is configured to couple directly to the frame 202 of the vehicle 200 as described above. Further, the fasteners 362 are a first set of fasteners, and the winch assembly 312 further comprises a second set of fasteners 363. The first set of fasteners 362 couple the fairlead 336 to the housing 334 (specifically, the front housing side 340). The second set of fasteners 363 couple the housing 334 to the bumper 311 of the vehicle 300.

As illustrated in FIG. 3F, slot 350 is formed in a lower portion of fairlead 336, as opposed to the upper slot 250 of fairlead 236. Rope or cable 320 is wound around drum 318 in the opposite direction as compared to rope or cable 220 (FIG. 2F). The slot 350 aligns with the end of the rope or cable 320 extending off the bottom of drum 318. As illustrated in FIGS. 3D and 3E, sensor 332 is also repositioned lower to remain adjacent to slot 350 in order to sense the presence (or absence) of winch head 322.

Referring to FIGS. 3D and 3E, the mounting platforms 366 of the fairlead 336 differ from the mounting platforms 266. For example, while the mounting platforms 266 protrude from the underlying structure of the fairlead 236, the mounting platforms 366 are formed as divots inset into the fairlead 336 (specifically, in the rear fairlead side 348). The front housing side 338 includes housing mount protrusions 337 that protrude outward from the front housing side 340. The housing mount protrusions 338 correspond in location and size to the mounting platforms 366. The mounting platforms 366 receive the housing mount protrusions 338 to align the fairlead 336 to the housing 334.

Referring now to FIG. 3F, the winch assembly 312 further includes a cover 368 that covers the top housing side 338. The first electrical connector 328 may extend from the top housing side 338; therefore, the cover 368 may protect the first electrical connector 328 from environmental conditions.

Advantageously, the compact winch designs described herein eliminate fasteners and interface connections, thereby minimizing potential failure points. The present winch designs may be attached directly to the chassis of the vehicle, maximizing strength and rigidity of the system while minimizing weight and occupied space. This space savings also may allow the winch assembly to be mounted closer to the vehicle's mounting surface, which can improve the approach angle of the vehicle compared to conventional winch designs.

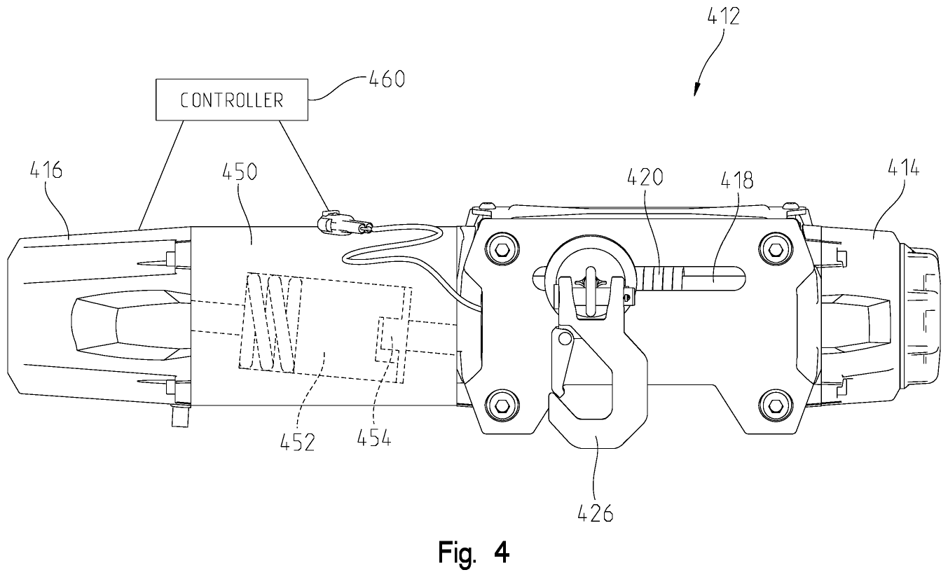

Turning now to FIG. 4, a winch made in accordance with the present disclosure may include an impact mechanism 450 operably disposed between the winch motor 416 and the drum 418. For convenience, winch assembly 412 is shown in FIG. 4, it being understood that the impact mechanism 450 can be applied to any winch design, including to winch assemblies 112, 212, or 312.

Impact mechanism 450 uses a striker, such as striker 452, to successively deliver rotational striking blows to rotator 454. Striker 452 may be powered directly by motor 416, and gathers momentum between each pair of rotational striking blows. This momentum is delivered to rotator 454 during each blow, creating a torque spike which is delivered to the drum 418 and, ultimately, to any load connected to the roe or cable 420. These torque spikes provide brief but intense torquing of drum 418, enabling winch assembly 412 to handle larger loads than conventional winches of otherwise comparable power. Thus, rather than relying on torque from motor 416 to deliver steady rotational motion of the drum 418, impact mechanism 450 can use smaller motor torque at higher speed to advance the drum 418 one gear step at a time under heavy load. Under light load, the impact mechanism would allow the winch to advance multiple steps at a time, significantly speeding up retraction speed of the rope or cable 420.

In the illustrated embodiment, gearbox 414 is functionally disposed between impact mechanism 450 and drum 418, such that the torque spikes from impact mechanism 450 are transmitted gearbox 414, which in turn passes the torque spikes to drum 418 after a gear reduction. Advantageously, the uses of impact mechanism 450 may allow for either greater performance or a lesser gear reduction for the same level of performance. For example, gearbox 414 may employ a single- or double-stage reduction, rather than a three-stage reduction as may otherwise be typical. In some embodiments, impact mechanism 450 may facilitate the complete removal of gearbox 414, such that drum 418 is driven directly by the output from impact mechanism 450. Thus, the use of impact mechanism 450 may significantly reduce the size, weight, and cost of the motor 416 and/or gearbox 414 with no reduction in the overall performance characteristics of winch assembly 412.

In the illustrated embodiment, striker 452 is a collar which rotates a stepped portion. With each full rotation, the stepped portion impacts a correspondingly formed step on the rotator 454. Thus, the illustrated embodiment is a mechanical-type impact mechanism. In some embodiments, striker 452 and rotator 454 are hydraulically coupled, which provides similar torque delivery characteristics but quieter operation. In some embodiments, a ratchet mechanism or brake may be used to prevent unintended backspinning of the drum 418 when motor 416 is not operating.

Winch assembly 412 also includes a controller 460 which is programmed or otherwise configured to selectively activate motor 416, as well as receive signals from an operator, sensors such as sensor 132, 232, 332, or other vehicle systems. Controller 460 is described herein with reference to winch assembly 412 for convenience, it being understood that winch assemblies 112, 212, 312 may also use the same controller, and that vehicles 100, 200, 300 may have the controller integrated therein together with other vehicle controls.

In one embodiment, controller 460 may be programmed or otherwise configured to use the winch assembly 412 to rock the vehicle to which winch assembly 412 is attached. That is, controller 460 may be programmed or otherwise configured to alternately and iteratively let out and retract the rope or cable 420 such that, when the hook 426 is attached to a stationary object, the vehicle is rocked back and forth creating increasing momentum in both directions. In some embodiments, this rocking function can be accessed as a mode of operation selectable by the operator of the vehicle, e.g., by accessing the mode from a graphical user interface within the cabin of the vehicle.

For example, the controller 460 may measure the feedback torque within motor 416 and determine, based on the feedback torque, when the vehicle has reached the peak or zenith of its ability to move further in its current direction. The controller 460 may receive, from the motor 416, a signal indicative of a torque of the motor 416. The controller may further determine, based on the signal indicative of the torque, the peak torque. The controller 460, in response to determining the peak, may switch direction, e.g., cause application power to the motor 416 to move the vehicle in the opposite direction until the opposite peak or zenith is reached. The controller 460, in response to determining the opposite peak, may again switch direction. In some examples, the controller 460 is programmed or otherwise configured to switch the direction of the motor, in response to determining the peak torque. This process may be repeated until the vehicle is free, e.g., such that no peak or zenith is reached because the vehicle can move freely, or until the operator stops the process. Advantageously, this programming methodology allows the winch assembly 412 to move an object that requires more force than the motor 416 is able to provide on its own. This control methodology can be used with winches including or excluding an impact mechanism 450 as described above.

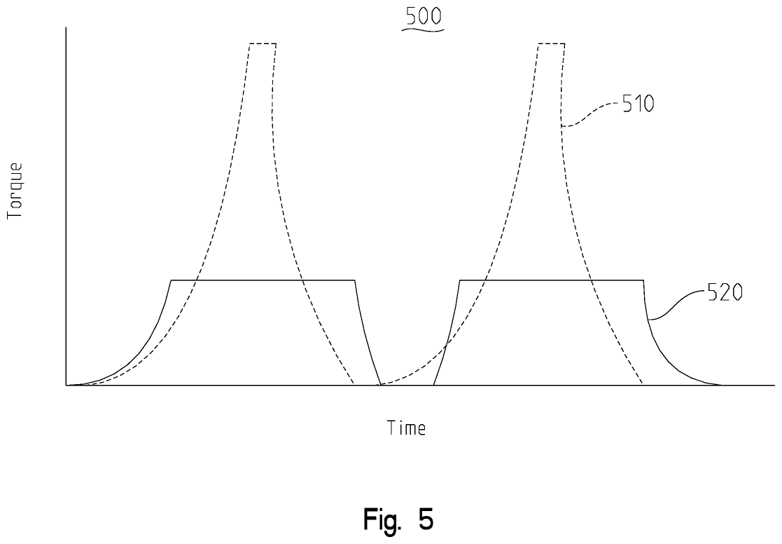

FIG. 5 illustrates a graph 500 of performance characteristics of an impact torque mechanism according to some embodiments of the present disclosure. The graph 500 plots Torque versus Time. As mentioned above, in some embodiments of winch assemblies according to the present disclosure, an impact torque mechanism (e.g., impact torque mechanism 450) includes a striker (e.g., striker 452) and a rotator (e.g., rotator 454) that are hydraulically coupled such that the striker must travel through a bath of oil to rotate the rotator. The striker and the rotator may be hydraulically coupled for the advantages of reducing noise, and increasing durability.

Graph 500 includes a first plot 510 of performance characteristics for a mechanical impact torque mechanism (e.g., where the striker and rotator are mechanically coupled). Generally, the first plot 510 includes instances of relatively high torque that occur in a relatively short period of time. Graph 500 further includes a second plot 520 of performance characteristics for a hydraulic impact torque mechanism (e.g., where the striker and rotator are hydraulically coupled). As illustrated in FIG. 5, the second plot 520 includes instances of torque that with lower peak values compared to the torque instances of the first plot 510, but that occur over a greater period of time than the first plot 510. In other words, the torque of the second plot 520 is damped with respect to the torque of the first plot 510. This damping effect may be accomplished by the transfer of torque from the striker 452 to the rotator 450 via oil positioned between them, rather than by direct mechanical contact.

With respect to plot 520, the impact of the striker (e.g., striker 452) on a rotator (e.g., rotator 454) may be damped because the strikers are located in an oil bath that extends a duration of an impact between the striker and the rotator. Visually, such a result is shown on graph 500, where the torque spikes are spread out over a longer time period than the torque spikes of plot 510. If an impact torque mechanism is used frequently, it may be beneficial to reduce noise and increase durability of the winch assembly, by using a hydraulic driven impact torque mechanism (e.g., where the striker and the rotator engage by way of hydraulics). For example, in accordance with some embodiments disclosed herein, noise generated by the impact torque mechanism may be reduced by as much as 50% when the impact torque mechanism is hydraulically driven, as compared to when the striker, which may be made of metal, and the rotator, which may also be made of metal, mechanically impact each other (e.g., without hydraulic dampers).

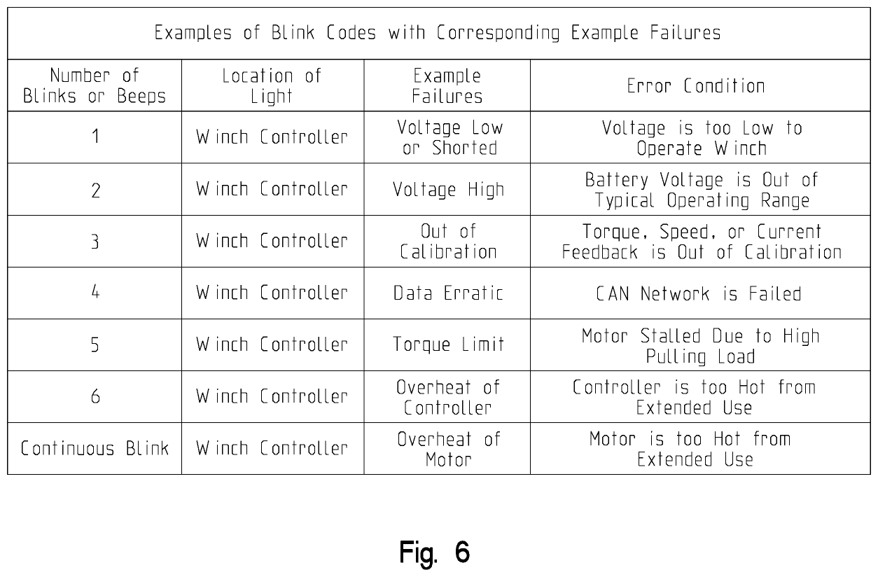

Turning now to FIG. 6, additional detail for controller 460 are provided. In particular, FIG. 6 illustrates an example table of error codes or conditions for a controller (e.g., controller 460). Generally, brushless DC motors (such as motor 116, 216, 316, 416, in some example embodiments described above) may benefit from pairing with a smart or programmable controller (e.g., controller 460 discussed above with respect to FIG. 4). A smart controller, including controller 460, may be an example of a computing device that can be used to control a winch assembly based on, for example, programming, algorithms, sensor feedback, user input, or combinations thereof.

In conventional vehicle examples that include a winch assembly, when the vehicle becomes inoperable, the winch may also become inoperable. For example, if the vehicle includes a controller area network (CAN) that allows electrical components of the winch assembly to be controlled by a controller (e.g., controller 460) on the vehicle, then if the CAN becomes deactivated, the controller can no longer communicate with the winch assembly. The winch assembly may thereby be rendered inoperable. Further, when the CAN is down, the winch assembly, or aspects thereof, may be unable to communicate error conditions (e.g., error conditions of FIG. 6) to a vehicle, or user thereof. In such instances, it may be beneficial to provide an indication of the error conditions, to the user, local to the winch assembly (e.g., without needing a CAN). Additionally, in some conventional examples, winch assemblies may overheat when paired with a smart controller and thereby be rendered inoperable.

Aspects of the present disclosure address, at least, the above mentioned deficiencies. For example, controller 460 may be programmed or otherwise configured to detect a number of different error conditions in connection with the function of the vehicle systems, including mechanical and computer systems. Controller 460 may issue a signal indicative of an error code corresponding to the error condition detected, or multiple error code signals may be issued if there are multiple error conditions. Controller may be further programmed or otherwise configured to notify a user (e.g., via an audio and/or visual indicator) of one or more of a plurality of error conditions, such that corrective actions may be taken, as discussed further herein.

As a first error code or condition example, voltage may be too low to operate a winch (e.g., of the winch assembly 112, 212, 312, 412). For example, the winch may receive voltage from a power source, and the voltage may be lower than a threshold that is required to operate the winch. In some examples, the winch may be operated by a battery, and a voltage of the battery may be lower than the threshold that is required to operate the winch if the battery has a low state of charge. When the first error condition is reached, a signal may issue from controller 460 such that a user may be notified that the battery or power source must be checked (e.g., maintenance may need to be performed, the power source may need to be replaced, and/or other corrective action may need to be taken). The user may be notified of the first error condition example via an audio and/or visual indicator. For example, the user may be notified of the first error condition example by a single blink of a light (e.g., an LED) that is located on the controller (e.g., controller 460), on the winch, or any other suitable location. Additionally, or alternatively, the user may be notified of the first error condition example by a single beep that is emitted from the controller (e.g., controller 460) or an audio device operably connected to the controller. After the user is notified, the user may take corrective action to address the first error condition.

As a second error code or condition example, voltage may be too high to operate a winch (e.g., of the winch assembly 112, 212, 312, 412). For example, the winch may receive voltage from a power source, and the voltage may be higher than a threshold that is acceptable to operate the winch (e.g., the power source may have a voltage operating range, and a value of the voltage may be higher than an upper bound value of the voltage operating range). In some examples, the winch may be operated by a battery, and a voltage of the battery may be higher than the threshold that is required to operate the winch. When the second error condition is reached, a signal may issue from controller 460 such that a user may be notified that the battery or power source must be checked (e.g., maintenance may need to be performed, the power source may need to be replaced, and/or other corrective action may need to be taken). The user may be notified of the second error condition example via an audio and/or visual indicator. For example, the user may be notified of the second error condition example by two blinks of a light (e.g., an LED) that is located on the controller (e.g., controller 460), on the winch, or any other suitable location. Additionally, or alternatively, the user may be notified of the second error condition example by two beeps that are emitted from the controller (e.g., controller 460) or an audio device operably connected to the controller. After the user is notified, the user may take corrective action to address the second error condition.

As a third error code or condition example, a controller (e.g., controller 460) may be out of calibration. For example, the control may transmit and/or receive feedback corresponding to operational parameters of the winch assembly, such as, for example torque, speed, electrical current, and the like. The controller may need to be calibrated (e.g., prior to initial use, and/or at regular intervals subsequent to the initial use), such that the controller can accurately control operational parameters of the winch assembly. The controller may be calibrated to control a torque (e.g., of the motor 116, 216, 316, 416) that is applied to rotate a drum of the winch assembly, and/or to control a speed at which a rope or cable is wound into, or unwound from, a housing of the winch assembly, and/or to control the amount of electrical current flowing to the winch motor. When the third error condition is reached, a signal may issue from controller 460 such that a user may be notified that the controller must be checked (e.g., maintenance may need to be performed, the controller may need to be replaced, the controller may need to be calibrated, and/or other corrective action may need to be taken). The user may be notified of the third error condition example via an audio and/or visual indicator. For example, the user may be notified of the third error condition example by three blinks of a light (e.g., an LED) that is located on the controller (e.g., controller 460), on the winch, or any other suitable location. Additionally, or alternatively, the user may be notified of the third error condition example by three beeps that are emitted from the controller (e.g., controller 460) or an audio device operably connected to the controller. After the user is notified, the user may take corrective action to address the third error condition.

As a fourth error code or condition example, a controller area network (CAN) may have failed. For example, data transmissions across the CAN may cease to occur, or be erratic. As discussed earlier herein, when a CAN network is failed, a controller may be unable to communicate with a corresponding vehicle, and thereby be unable to provide signals, or indications related to such signals, to a user. Accordingly, to recognize that the CAN has failed, systems described herein may provide an indication to the user, of the failed CAN, local to the controller of the winch assembly. When the fourth error condition is reached, a signal may issue from controller 460 such that a user may be notified that hardware and/or software related to the CAN must be checked (e.g., maintenance may need to be performed, software related to the CAN may need to be updated, hardware related to the CAN may need to be replaced, and/or other corrective action may need to be taken). Further, the user may be notified of the fourth error condition example via an audio and/or visual indicator. For example, the user may be notified of the fourth error condition example by four blinks of a light (e.g., an LED) that is located on the controller (e.g., controller 460), on the winch, or any other suitable location. Additionally, or alternatively, the user may be notified of the fourth error condition example by four beeps that are emitted from the controller (e.g., controller 460) or an audio device operably connected to the controller. After the user is notified, the user may take corrective action to address the fourth error condition.

As a fifth error code or condition example, a torque limit of a winch motor may be at a maximum operational value. For example, the motor may be stalled due to a relatively high (e.g., heavy) pulling load. When the fifth error condition is reached, a signal may issue from controller 460 such that a user may be notified that the motor and/or a configuration of the load being pulled must be checked (e.g., maintenance may need to be performed, the motor may need to be replaced, the load may need to be reduced, and/or other corrective action may need to be taken). The user may be notified of the fifth error condition example via an audio and/or visual indicator. For example, the user may be notified of the fifth error condition example by five blinks of a light (e.g., an LED) that is located on the controller (e.g., controller 460), on the winch, or any other suitable location. Additionally, or alternatively, the user may be notified of the fifth error condition example by five beeps that are emitted from the controller (e.g., controller 460) or an audio device operably connected to the controller. After the user is notified, the user may take corrective action to address the fifth error condition.

As a sixth error code or condition example, a controller may be overheated. For example, the controller may be overheated due to extended use, and/or environmental conditions (e.g., temperature, moisture, etc.) in which the controller is operating. When the sixth error condition is reached, a signal may issue from controller 460 such that a user may be notified that the controller must be checked (e.g., maintenance may need to be performed, the controller may need to be replaced, usage of the controller may need to be reduced in duration and/or intensity, and/or other corrective action may need to be taken). The user may be notified of the sixth error condition example via an audio and/or visual indicator. For example, the user may be notified of the sixth error condition example by six blinks of a light (e.g., an LED) that is located on the controller (e.g., controller 460), on the winch, or any other suitable location. Additionally, or alternatively, the user may be notified of the sixth error condition example by six beeps that are emitted from the controller (e.g., controller 460) or an audio device operably connected to the controller. After the user is notified, the user may take corrective action to address the sixth error condition.

As a seventh error code or condition example, a motor of a winch assembly (e.g., motor 116, 216, 316, 416) may be overheating or not functional. For example, the motor may be overheated due to extended use, and/or environmental conditions (e.g., temperature, moisture, etc.). When the seventh error condition is reached, a signal may issue from controller 460 such that a user may be notified that the winch assembly, or part thereof (e.g., the motor), must be checked (e.g., usage of the motor may need to be reduced in duration and/or intensity, maintenance may need to be performed, the motor may need to be replaced, and/or other corrective action may need to be taken). The user may be notified of the seventh error condition example via an audio and/or visual indicator. For example, the user may be notified of the seventh error condition example by continuous blinks of a light (e.g., an LED) that is located on the controller (e.g., controller 460). Additionally, or alternatively, the LED may be located elsewhere on the winch assembly (e.g., on the motor, or a housing of the winch assembly, etc.). Additionally, or alternatively, the user may be notified of the seventh error condition example by a continuous beep or tone are emitted from the controller or an audio device operably connected to the controller. After the user is notified, the user may take corrective action to address the seventh error condition.

While the above error conditions have been described with specific methods of providing an indication to a user to notify the user of each of the error conditions, further method of providing an indication to the user will be recognized by those of ordinary skill in the art. For example, a vehicle (e.g., vehicle 100, 200, 300) may include a user interface (e.g., an in-vehicle infotainment console). The user interface may be configured to provide an indication to the user of one or more of the seven error condition examples discussed with respect to FIG. 6. Specifically, one or more audio and/or visual notification may be generated by the user interface (e.g., the in-vehicle infotainment console) to notify a user that components of the vehicle may need to be checked (e.g., battery, power source, motor, winch assembly, etc.).

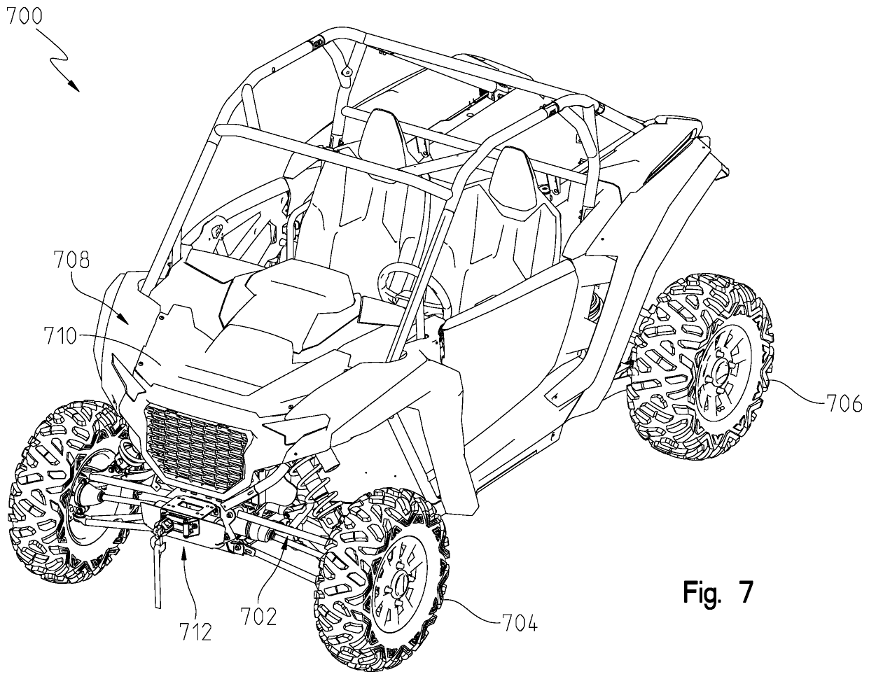

With reference to FIG. 7, an example vehicle 700 is shown. The vehicle 700 may be an all-terrain vehicle (ATV), a utility terrain vehicle (UTV), or other off-road vehicle (ORV). In other examples, vehicle 700 may include other vehicles, including, but not limited to, boats, personal transport vehicles, or other recreational vehicles. The vehicle 700 is shown generally to include a frame 702 supported by a plurality of ground engaging members, for example, front wheels 704 and rear wheels 706. The vehicle 700 includes a front end 708 having a hood 710, an engine (not shown), and a winch assembly 712 coupled to the frame 702. The winch assembly 712 may be directly coupled to the frame 102 (e.g., via one or more bolts, screws, or rivets), as further described in detail below.

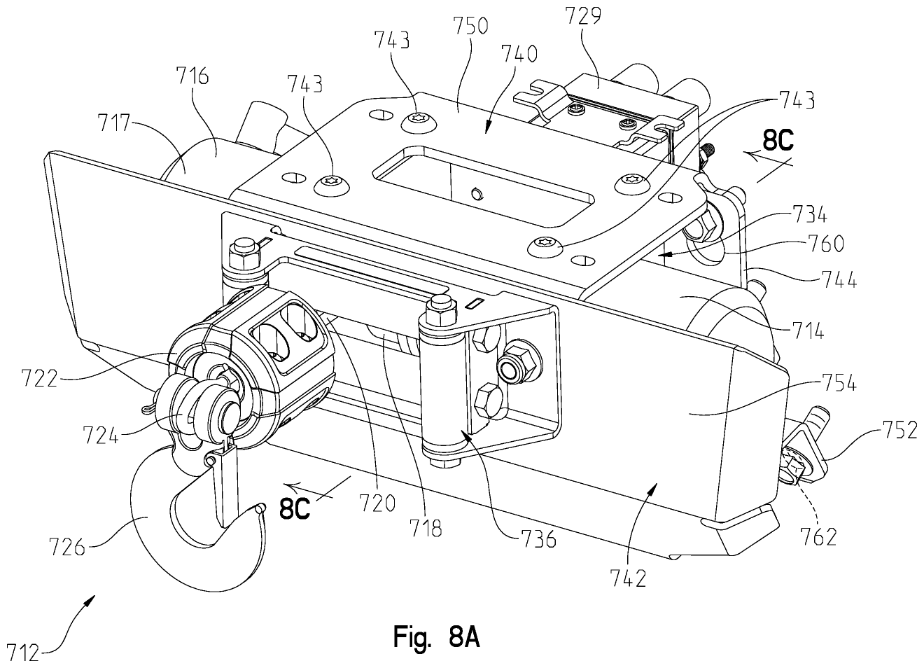

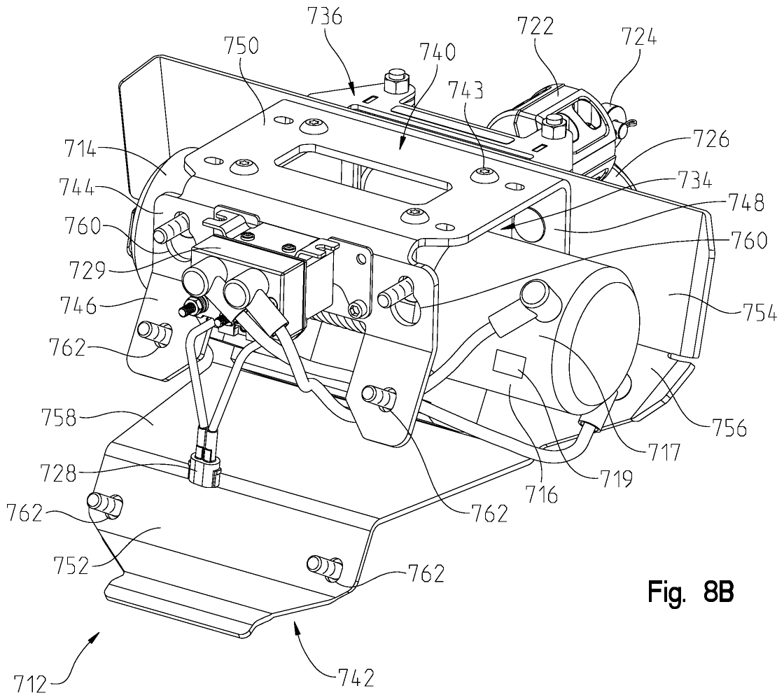

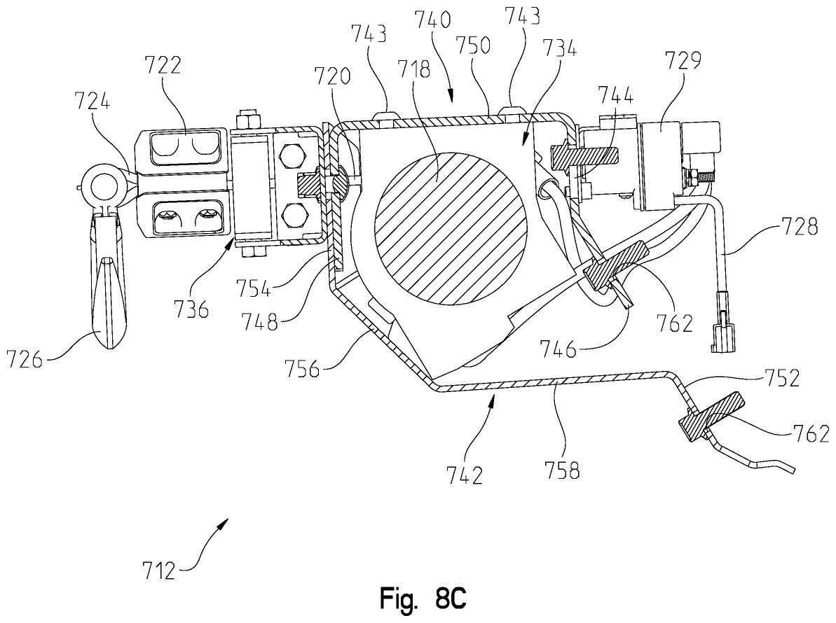

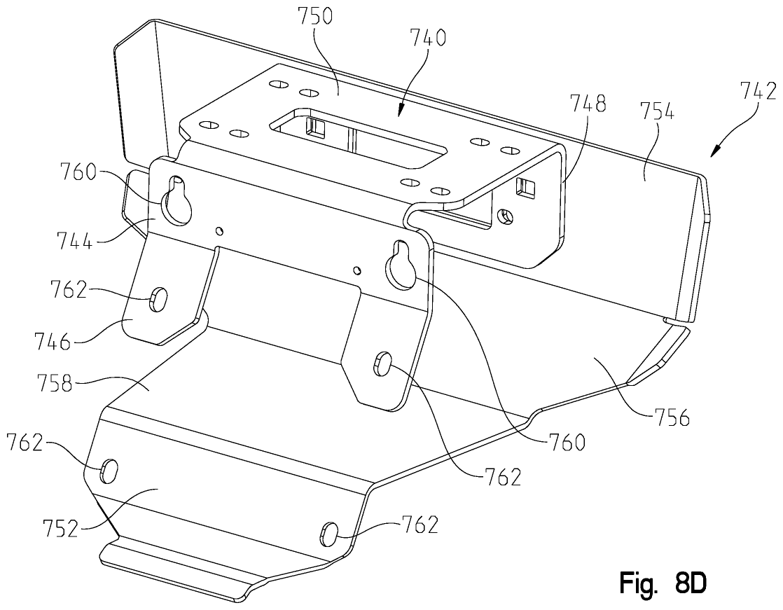

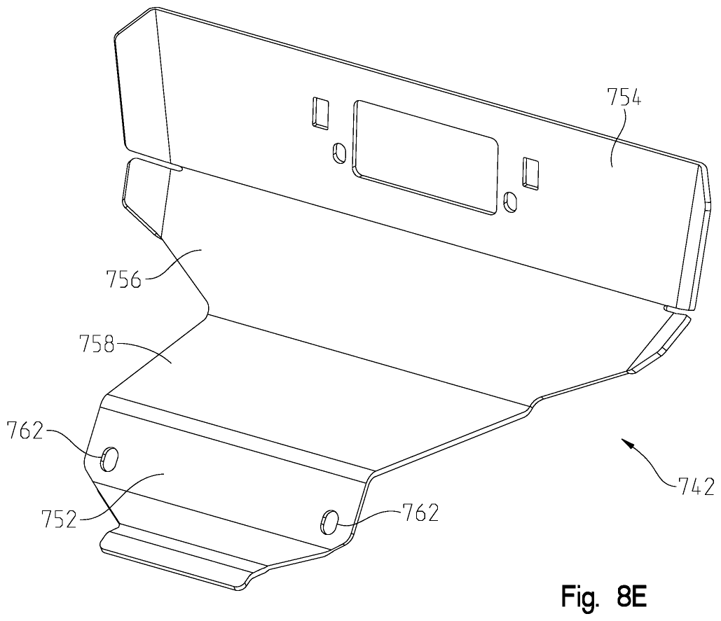

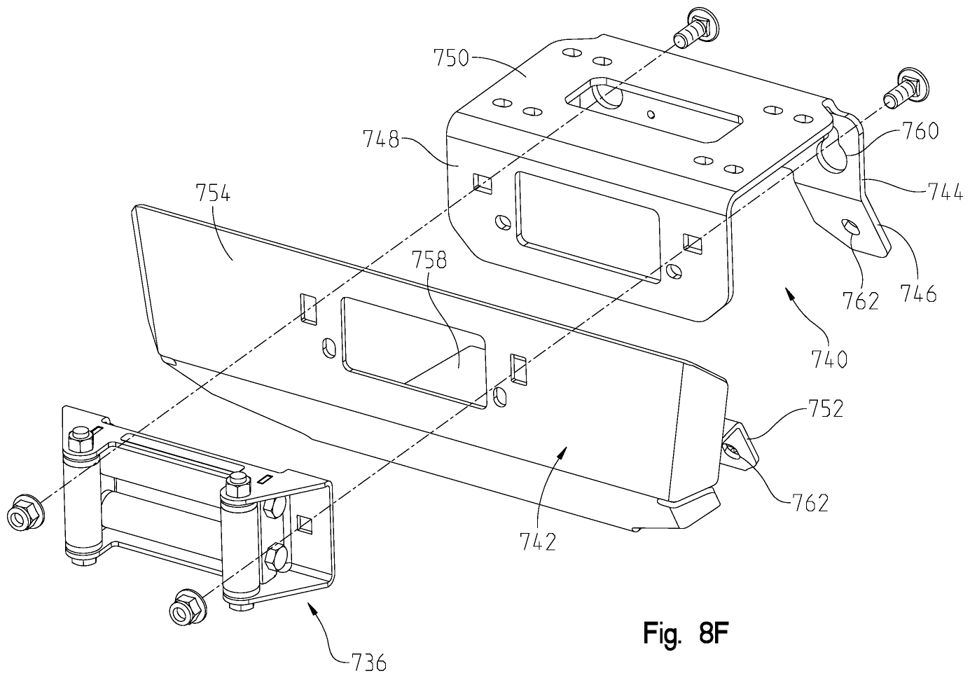

The winch assembly 712 is illustrated further in FIGS. 8A-8F. In some aspects, the winch assembly 712 may be substantially similar to the winch assembly 112, discussed with respect to FIGS. 1-1F, except for the differences as described herein.

Similar elements between winch assembly 112 and winch assembly 712 are provided with similar reference numbers that have been incremented by 600. For example, winch assembly 712 includes a gearbox 714, a motor 716, a drum 718, an isolator 719, a rope or cable 720, a winch head 722, a winch hook 724, a load hook 726, an electrical connector 728, a contactor 729, a housing 734, and a fairlead 736.

In some aspects, the winch assembly 712 differs from the winch assembly 112. For example, as shown in FIGS. 8A-8F, the winch assembly 712 includes at least one bracket, such as a first bracket 740 and a second bracket 742. In some examples, the winch assembly 712 includes only the first bracket 740 or only the second bracket 742. In some examples, the first bracket 740 and the second bracket 742 are coupled together, such as removably coupled together via fasteners. In some examples, the first bracket 740 and the second bracket 742 may instead be a single bracket that encloses the housing 734 and/or the drum 718 of the winch assembly 712. In some examples, the first bracket 740 and/or the second bracket 742 may have relatively uniform thickness.

The first bracket 740 and/or the second bracket 742 extend about the housing 734 and/or the drum 718. Further, the housing 734 may be coupled to the first bracket 740 and/or the second bracket 742, such as via one or more fasteners 743. The first bracket 740 includes a first mounting surface 744 at which the first bracket 740 is configured to mount to the vehicle 700. The first mounting surface 744 defines a first plane. The first bracket 740 further includes a second mounting surface 746 at which the first bracket 740 is configured to mount to the vehicle 700. The second mounting surface 746 defines a second plane. The first plane defined by the first mounting surface 744 and the second plane defined by the second mounting surface 746 are non-coplanar.

The first bracket 740 further defines a front surface 748 and a top surface 750. The one or more fasteners 743 may extend through the top surface 750 of the first bracket 740 to mount the housing 734 to the first bracket 740. The top surface 750 may be generally orthogonal to one or more of the front surface 748 and the first mounting surface 744. Further, the first mounting surface 744 may be laterally opposed from the front surface 748. Edges between the front surface 748, the top surface 750, the first mounting surface 744, and/or the second mounting surface 746 may be rounded such as to dissipate forces while the winch assembly 712 is in a load carrying application.

By coupling the winch assembly 712 to the vehicle 700 on two different planes, as defined by the first mounting surface 744 and the second mounting surface 746, the winch assembly 712 may be relatively stronger than winch assemblies that do not couple to the vehicle on two different planes. For example, in some use applications, bolts that extend through the first mounting surface 744 may be subject to tension loads while bolts that extend through the second mounting surface 746 may be subject to shear load, or vice versa. Therefore, loads may help to be distributed via the two different planes of the first mounting surface 744 and the second mounting surface 746.

In some examples, the second bracket 742 includes a third mounting surface 752 at which the second bracket 742 is configured to mount to the vehicle 702. The third mounting surface 752 defines a third plane. In some examples, the third plane is coplanar with the second plane, such that the third mounting surface 752 and the second mounting surface 746 are coplanar. Further, the second bracket 742 may include a front surface 754 and one or more intermediate surface, such as first intermediate surface 756 and second intermediate surface 758, that extend between the front surface 754 and the third mounting surface 752. Generally, including the second bracket 742 in the winch assembly 712, with the first bracket 740, may allow for increased strength and/or durability of the winch assembly 712.

In some examples, the first bracket 740 and the second bracket 742 enclose the housing 734. For example, the first bracket 740 and the second bracket 742 may enclose the drum 718, the motor 716, and/or the gearbox 714. Further, the front surface 754 and/or one or more of the intermediary surfaces 756, 758 of the second bracket 742 may include one or more flanges that help to shield the winch assembly 712, such as from debris.

In some examples, the first mounting surface 744 includes a plurality of keyhole openings 760. Additionally, or alternatively, one or more keyhole openings may be defined by second mounting surface 746 and/or third mounting surface 752. Fasteners, such as bolts, screws, rivets, or the like may extend through the keyhole openings 760 to couple the first bracket 740 to the vehicle 700. The keyhole openings 760 may assist in ease of assembly by allowing the winch assembly 712 to be slid onto fasteners that are already attached to the vehicle 700 by passing the head of such a fastener through the larger portion of the keyhole opening 760 and then sliding the shank of such a fastener into the smaller portion of the keyhole opening 760. After being slid onto the fasteners, an installer may use a wrench or other tool to tighten the fasteners onto the first bracket 740, thereby easily securing the winch assembly 712 onto the vehicle 700. Subsequently, one or more fasteners may be inserted through one or more apertures 762 in the second mounting surface 746 and/or the third mounting surface 744 to further secure the winch assembly 712 to the vehicle 700. In some examples, pairs of the keyholes 760 may be spaced apart at the same width as pairs of the apertures 762 on the second mounting surface 746 and/or the third mounting surface 744. Components provided herein may advantageously improve installation and/or increase strength. Additional and/or alternative advantages may be recognized by those of ordinary skill in the art, at least in light of teachings described herein.

In some examples, the fairlead 736 may be integral to the first bracket 740 and/or the second bracket 742. In some examples, the fairlead 736 may be coupled (e.g., removably coupled) to the front surface 748 of the first bracket 740. In some examples, the fairlead 736 may be coupled (e.g., removably coupled) to the front surface 754 of the second bracket 742. As shown in, for example, FIGS. 8C and 8F, the fairlead 736, the front surface 754 of the second bracket 740, and the front surface 748 of the first bracket 740 may be coupled together, such that the front surface 754 of the second bracket 742 is between and/or in contact with the fairlead 736 and the front surface 748 of the first bracket 740.

In some examples, the winch assembly 112, 212, and/or 312 described earlier herein may be original equipment manufacturer (OEM) winch assemblies. In some examples, the winch assembly 712 may be an after-market winch assembly with components, such as the first bracket 740 and the second bracket 742, that may be assembled with winch components described earlier herein and/or other winch components that may be known to those of ordinary skill in the art.

The following clauses illustrate example subject matter described herein.

Clause 1. A winch assembly, comprising: a motor; a drum driven by the motor; a housing, the drum extending through the housing; and a fairlead, the fairlead being directly coupled to a face of the housing, wherein the fairlead is configured to couple to at least a portion of a vehicle via one or more fasteners.

Clause 2. The winch assembly of any of the clauses herein, wherein the fairlead and the housing, in combination, form an enclosure around the drum.

Clause 3. The winch assembly of any of the clauses herein, further comprising a gearbox having an input configured to receive shaft work from the motor and an output configured to rotate the drum, the drum extending between the motor and the gearbox.

Clause 4. The winch assembly of any of the clauses herein, wherein the fairlead includes a slot that extends longitudinally between the motor and the gearbox.

Clause 5. The winch assembly of any of the clauses herein, wherein the fairlead has a generally convex curvature defined by its outer surface.

Clause 6. The winch assembly of any of the clauses herein, wherein the fairlead is directly coupled to the housing via the one or more fasteners.

Clause 7. The winch assembly of any of the clauses herein, wherein the housing is coupled directly to a vehicle, via the one or more fasteners.

Clause 8. The winch assembly of any of the clauses herein, further comprising a cable, the cable being wrapped around the drum, and the cable including a winch head, the winch head configured to accept a winch hook.

Clause 9. The winch assembly of any of the clauses herein, further comprising a sensor, the sensor being coupled directly to the fairlead adjacent to a slot formed in the fairlead that extends longitudinally between the motor and the gearbox.

Clause 10. The winch assembly of any of the clauses herein, wherein the sensor is an inductive sensor, the inductive sensor being configured to detect a state of the winch head.

Clause 11. The winch assembly of any of the clauses herein, wherein the winch head includes a ferrous metal, and wherein the inductive sensor senses the presence of the ferrous metal when the winch head is a fully retracted position.

Clause 12. The winch assembly of any of the clauses herein, wherein the fairlead includes a first side and a second side, and wherein a plurality of ribs are formed in the second side.

Clause 13. The winch assembly of any of the clauses herein, further comprising at least one bracket extending about and coupled to the housing, wherein the at least one bracket comprises a first mounting surface configured to mount to a vehicle along a first plane and a second mounting surface configured to mount to the vehicle along a second plane, and wherein the first plane and the second plane are non-coplanar

Clause 14. A winch assembly, comprising: a motor; a drum driven by the motor; a housing, the drum extending through the housing; and a fairlead, the fairlead being coupled to the housing via one or more fasteners, and the housing being coupled directly to a vehicle, via the one or more fasteners.

Clause 15. The winch assembly of any of the clauses herein, further comprising a gearbox having an input which receives power from the motor and an output which provides power to the drum, the drum extending between the motor and the gearbox.

Clause 16. The winch assembly of any of the clauses herein, wherein the fairlead includes a slot that extends longitudinally between the motor and the gearbox.

Clause 17. The winch assembly of any of the clauses herein, wherein the fairlead includes a first side and a second side, wherein the slot extends through the fairlead, from the first side, and to the second side.

Clause 18. The winch assembly of any of the clauses herein, wherein the fairlead includes a depressed region, the depressed region being formed in the first side of the fairlead, and wherein the slot is disposed within the depressed region.

Clause 19. The winch assembly of any of the clauses herein, further comprising a sensor, the sensor being coupled directly to the second side of the fairlead adjacent to the slot.

Clause 20. The winch assembly of any of the clauses herein, wherein a plurality of ribs are formed in the second side of the fairlead.

Clause 21. A vehicle, comprising: a winch assembly, the winch assembly comprising: a motor; a drum driven by the motor; a housing, the drum extending through the housing, the housing directly coupled to the vehicle; and a fairlead, the fairlead being directly coupled to the housing.

Clause 22. The vehicle of any of the clauses herein, further comprising a gearbox having an input which receives power from the motor and an output which provides power to the drum, the drum extending between the motor and the gearbox

Clause 23. The vehicle of any of the clauses herein, wherein the vehicle further comprises a frame, wherein the fairlead is directly coupled to the housing by way of one or more fasteners, and wherein the one or more fasteners couple the fairlead and the housing to the frame of the vehicle.

Clause 24. The vehicle of any of the clauses herein, wherein the vehicle further comprises a bumper, wherein the fairlead is directly coupled to the housing, via a first set of fasteners, and wherein the housing is directly coupled to the bumper of the vehicle, via a second set of fasteners.

Clause 25. A winch assembly comprising: a motor; a drum; a housing, the drum extending through the housing; and an impact mechanism driven continuously by the motor and driving the drum with a series of rotational striking blows.

Clause 26. The winch assembly of any of the clauses herein, wherein the impact mechanism comprises: a striker coupled to an output of the motor; and a rotator configured to receive impact from the series of rotational striking blows from the striker, the rotator coupled to an input of the drum.

Clause 27. The winch assembly of any of the clauses herein, wherein the striker and the rotator are mechanically coupled.

Clause 28. The winch assembly of any of the clauses herein, wherein the striker and the rotator are hydraulically coupled.

Clause 29. The winch assembly of any of the clauses herein, wherein the striker travels through oil to deliver the impact to the rotator.

Clause 30. The winch assembly of any of the clauses herein, wherein the striker is made of metal, and the rotator is made of metal.

Clause 31. The winch assembly of any of the clauses herein, further comprising a ratchet mechanism or brake configured to prevent unintended backspinning of the drum when the motor is not operating.

Clause 32. A winch assembly comprising: a motor; a drum driven by the motor; a cable fixed to the drum and configured to be selectively wound around the drum and unwound from the drum by operation of the motor; a housing, the drum extending through the housing; and a controller programmed or otherwise configured to activate and deactivate the motor, the controller programmed or otherwise configured to alternately and iteratively rotate the drum in opposite directions, thereby unwinding and winding the cable.

Clause 33. The winch assembly of any of the clauses herein, wherein: the motor provides an output signal indicative of a torque of the motor, and the controller is programmed or otherwise configured to: receive, from the motor, a signal indicative of a torque of the motor; and determine, based on the signal indicative of the torque, a peak torque.

Clause 34. The winch assembly of any of the clauses herein, wherein, in response to determining the peak torque, the controller is programmed or otherwise configured to switch a direction of the motor.

Clause 35. The winch assembly of any of the clauses herein, wherein the controller is further programmed or otherwise configured to iteratively switch the direction of the motor and the drum upon reaching the peak in each of the two directions of the motor.

Clause 36. A winch assembly comprising: a motor; a drum driven by the motor; a housing, the drum extending through the housing; and a controller programmed to detect a plurality of error conditions and issue a signal indicative of one or more error codes respectively corresponding to the plurality of error conditions, the controller configured to provide an indication of the one or more error codes to a user.

Clause 37. The winch assembly of any of the clauses herein, wherein the one or more error codes comprises a first error code corresponding to a first error condition.

Clause 38. The winch assembly of any of the clauses herein, wherein the first error condition is one of low voltage from a power source, high voltage from a power source, the controller is out of calibration, a failed controller area network (CAN), a motor torque above a threshold, an overheated condition of the controller, and an overheated condition of the motor.

Clause 39. The winch assembly of any of the clauses herein, wherein the one or more error codes further comprises a second error code corresponding to a second, different error condition.

Clause 40. The winch assembly of any of the clauses herein, wherein: the first error condition is one of low voltage from a power source, high voltage from a power source, the controller is out of calibration, a failed controller area network (CAN), a motor torque above a threshold, an overheated condition of the controller, and an overheated condition of the motor; and the second error condition is another one of the low voltage from a power source, the high voltage from a power source, the controller is out of the calibration, the failed controller area network (CAN), the motor torque above a threshold, the overheated condition of the controller, and the overheated condition of the motor.

Clause 41. The winch assembly of any of the clauses herein, wherein the indication is a visual indication.

Clause 42. The winch assembly of any of the clauses herein, wherein the indication is provided to the user via an in-vehicle infotainment console.

Clause 43. The winch assembly of any of the clauses herein, wherein the visual indication is a light disposed on the controller.

Clause 44. The winch assembly of any of the clauses herein, wherein the indication is an audio indication.

Clause 45. A winch assembly, comprising: a motor; a drum driven by the motor; a housing, the drum extending through the housing; and at least one bracket, wherein the at least one bracket extends about the housing, wherein the housing is coupled to the at least one bracket, and wherein the at least one bracket comprises: a first mounting surface at which the at least one bracket is configured to mount to a vehicle, wherein the first mounting surface defines a first plane; and a second mounting surface at which the at least one bracket is configured to mount to the vehicle, wherein the second mounting surface defines a second plane, and wherein the first and second planes are non-coplanar; and a fairlead, the fairlead being coupled to a face of the at least one bracket.

Clause 46. The winch assembly of any of the clauses herein, wherein the at least one bracket comprises a first bracket and a second bracket, wherein the first bracket comprises the first mounting surface and the second mounting surface, and wherein the second bracket comprises a third mounting surface at which the second bracket is configured to mount to the vehicle, wherein the third mounting surface defines a third plane.

Clause 47. The winch assembly of any of the clauses herein, wherein the first bracket and the second bracket enclose the housing.

Clause 48. The winch assembly of any of the clauses herein, wherein the first bracket comprises a plurality of keyhole openings at which the first bracket is configured to mount to the vehicle.

While this invention has been described as having exemplary designs, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A winch assembly, comprising:
a motor;
a drum driven by the motor;
a housing, the drum extending through the housing; and
a fairlead, the fairlead being directly coupled to a face of the housing, wherein the fairlead is configured to couple to at least a portion of a vehicle via one or more fasteners.

2. The winch assembly of claim 1, wherein the fairlead comprises at least one bracket extending about and coupled to the housing, wherein the at least one bracket comprises a first mounting surface configured to mount to a vehicle along a first plane and a second mounting surface configured to mount to the vehicle along a second plane, and wherein the first plane and the second plane are non-coplanar.

3. The winch assembly of claim 1, further comprising a gearbox having an input configured to receive shaft work from the motor and an output configured to rotate the drum, the drum extending between the motor and the gearbox.

4. The winch assembly of claim 3, wherein the fairlead includes a slot that extends longitudinally between the motor and the gearbox.

5. The winch assembly of claim 3, further comprising a sensor, the sensor being coupled directly to the fairlead adjacent to a slot formed in the fairlead that extends longitudinally between the motor and the gearbox.

6. The winch assembly of claim 5, wherein the sensor is an inductive sensor, the inductive sensor being configured to detect a state of the winch head.

7. The winch assembly of claim 6, wherein the winch head includes a ferrous metal, and wherein the inductive sensor senses the presence of the ferrous metal when the winch head is a fully retracted position.

8. The winch assembly of claim 1, further comprising an impact mechanism driven continuously by the motor and driving the drum with a series of rotational striking blows.

9. The winch assembly of claim 1, wherein the fairlead is directly coupled to the housing via the one or more fasteners, and wherein the housing is coupled directly to a vehicle, via the one or more fasteners.

10. A winch assembly comprising:
a motor;
a drum;
a housing, the drum extending through the housing; and
an impact mechanism driven continuously by the motor and driving the drum with a series of rotational striking blows.

11. The winch assembly of claim 10, wherein the impact mechanism comprises:
a striker coupled to an output of the motor; and
a rotator configured to receive impact from the series of rotational striking blows from the striker, the rotator coupled to an input of the drum.

12. The winch assembly of claim 11, wherein the striker and the rotator are mechanically coupled.

13. The winch assembly of claim 11, wherein the striker and the rotator are hydraulically coupled.

14. The winch assembly of claim 13, wherein the striker travels through oil to deliver the impact to the rotator.

15. The winch assembly of claim 13, wherein the striker is made of metal, and the rotator is made of metal.

16. The winch assembly of claim 10, further comprising a ratchet mechanism or brake configured to prevent unintended backspinning of the drum when the motor is not operating.

17. A winch assembly, comprising:
a motor;
a drum driven by the motor;
a housing, the drum extending through the housing; and
at least one bracket, wherein the at least one bracket extends about the housing, wherein the housing is coupled to the at least one bracket, and wherein the at least one bracket comprises:
a first mounting surface at which the at least one bracket is configured to mount to a vehicle, wherein the first mounting surface defines a first plane; and
a second mounting surface at which the at least one bracket is configured to mount to the vehicle, wherein the second mounting surface defines a second plane, and wherein the first and second planes are non-coplanar; and
a fairlead, the fairlead being coupled to a face of the at least one bracket.

18. The winch assembly of claim 17, wherein the at least one bracket comprises a first bracket and a second bracket, wherein the first bracket comprises the first mounting surface and the second mounting surface, and wherein the second bracket comprises a third mounting surface at which the second bracket is configured to mount to the vehicle, wherein the third mounting surface defines a third plane.

19. The winch assembly of claim 18, wherein the first bracket and the second bracket enclose the housing.

20. The winch assembly of claim 18, wherein the first bracket comprises a plurality of keyhole openings at which the first bracket is configured to mount to the vehicle.
